(19) United States
(12) Patent Application Publication
(10) Pub. No.: US 2026/0133654 A1
(43) Pub. Date: May 14, 2026

(54) DISPLAY PANEL AND DISPLAY APPARATUS

(71) Applicant: Xiamen Tianma Display Technology Co., Ltd., Xiamen (CN)

(72) Inventors: Wenshuo LIN, Xiamen (CN); Huifang ZHOU, Xiamen (CN)

(21) Appl. No.: 19/435,581

(22) Filed: Dec. 29, 2025

(30) Foreign Application Priority Data
Apr. 22, 2025 (CN) 202510506585.2

(51) Int. Cl. G06F 3/041; G06F 3/044

(52) U.S. Cl. CPC G06F 3/04164; G06F 3/0446; G06F 2203/04107

(57) ABSTRACT

Provided are a display panel and a display apparatus. The display panel includes: a display region and a non-display region; a substrate; a touch electrode and a touch line, where the touch electrode is at least located in the display region, and the touch line is electrically connected to the touch electrode and located in the non-display region; a shielding structure located between the substrate and the touch electrode, where the shielding structure overlaps with the touch electrode in a direction perpendicular to a plane of the substrate; and a shielding trace including a first shielding line, where the first shielding line is located in the non-display region and at least partially surrounds the display region, and the first shielding line is electrically connected to the shielding structure; and the shielding trace receives a fixed voltage.

### CROSS-REFERENCE TO RELATED APPLICATION

The present application claims priority to Chinese Patent Application No. 202510506585.2, filed on Apr. 22, 2025, the content of which is incorporated herein by reference in its entirety.

### TECHNICAL FIELD

The present disclosure relates to the field of display technologies, and in particular, to a display panel and a display apparatus.

### BACKGROUND

In an electronic product having a touch function, signals and noise in a display region will affect touch precision. For example, an internal circuit of the display panel will generate various electrical signals, which will then propagate in the form of electromagnetic radiation to form noise, and these display signals and display noise will interfere with touch function signals, thereby affecting touch accuracy.

### SUMMARY

Embodiments of the present disclosure provide a display panel and a display apparatus, which can be used for better shielding the interference of display signals and display noise on touch control.

In a first aspect, an embodiment of the present disclosure provides a display panel, including:

a display region and a non-display region;

a substrate;

a touch electrode and a touch line, where the touch electrode is at least located in the display region, and the touch line is electrically connected to the touch electrode and located in the non-display region;

a shielding structure located between the substrate and the touch electrode, where the shielding structure overlaps with the touch electrode in a direction perpendicular to a plane of the substrate; and

a shielding trace including a first shielding line, where the first shielding line is located in the non-display region and at least partially surrounds the display region, and the first shielding line is electrically connected to the shielding structure; and the shielding trace receives a fixed voltage.

In a second aspect, based on the same inventive concept, an embodiment of the present disclosure further provides a display apparatus including the above-mentioned display panel.

The technical solutions provided in the embodiments of the present disclosure have the following beneficial effects:

In the display panel according to the embodiment of the present disclosure, the shielding structure is disposed below the touch electrode, and the shielding structure can be configured to shield the interference of a display signal and display noise on a touch function signal. For example, the shielding structure 4 may weaken the interference of the display noise on a touch signal on the touch electrode. Or, when a touch tool such as an active stylus is used to control the display panel, the touch tool communicates and interacts with the touch electrode, and the shielding structure can also weaken the interference of the display signal on a signal emitted by the touch tool.

Further, in the embodiments of the present disclosure the first shielding line is further provided for providing a shielding signal to the shielding structure. The first shielding line surrounds the display region, and in turn the shielding structure can establish connections with the first shielding line at a plurality of positions. For example, in four bezels (upper, lower, left, and right), the shielding structure is connected to the first shielding line, thereby improving the uniformity of the shielding signal in the display region, enhancing the shielding capability, and thus improving the touch performance to a greater extent.

### BRIEF DESCRIPTION OF DRAWINGS

In order to more clearly illustrate technical solutions in embodiments of the present disclosure or in the prior art, the accompanying drawings required for describing the embodiments or the prior art will be briefly introduced below. Apparently, it should be noted that the accompanying drawings in the following description are merely some embodiments of the present disclosure, and other drawings can also be obtained by those of skill in the art according to these drawings without any creative efforts.

FIG. 1 is a structural schematic diagram of a display panel according to an embodiment of the present disclosure;

FIG. 2A is a schematic diagram of a film layer structure of a display panel according to an embodiment of the present disclosure;

FIG. 2B is a schematic diagram of another film layer structure of a display panel according to an embodiment of the present disclosure;

FIG. 3 is an enlarged structural schematic diagram of a region A in FIG. 1;

FIG. 4 is another enlarged structural schematic diagram of a region A in FIG. 1;

FIG. 5 is a schematic diagram of a connection between a shielding structure and a first shielding line according to an embodiment of the present disclosure;

FIG. 6 is a schematic diagram of another connection between a shielding structure and a first shielding line according to an embodiment of the present disclosure;

FIG. 7 is yet another structural schematic diagram of a display panel according to an embodiment of the present disclosure;

FIG. 8 is yet another structural diagram of a display panel according to an embodiment of the present disclosure;

FIG. 9 is still another structural schematic diagram of a display panel according to an embodiment of the present disclosure;

FIG. 10 is a partial structural schematic diagram of a display panel according to an embodiment of the present disclosure;

FIG. 11 is another partial structural schematic diagram of a display panel according to an embodiment of the present disclosure;

FIG. 12 is yet another partial structural schematic diagram of a display panel according to an embodiment of the present disclosure;

FIG. 13 is still another partial structural schematic diagram of a display panel according to an embodiment of the present disclosure;

FIG. 14 is a sectional view in a direction A1-A2 in FIG. 13;

FIG. 15 is yet another partial structural schematic diagram of a display panel according to an embodiment of the present disclosure;

FIG. 16 is still another structural schematic diagram of a display panel according to an embodiment of the present disclosure;

FIG. 17 is still another structural schematic diagram of a display panel according to an embodiment of the present disclosure;

FIG. 18 is still another structural schematic diagram of a display panel according to an embodiment of the present disclosure;

FIG. 19 is still another partial structural schematic diagram of a display panel according to an embodiment of the present disclosure;

FIG. 20 is still another partial structural schematic diagram of a display panel according to an embodiment of the present disclosure;

FIG. 21 is a schematic diagram of another film layer structure of a display panel according to an embodiment of the present disclosure;

FIG. 22 is a schematic diagram of yet another film layer structure of a display panel according to an embodiment of the present disclosure;

FIG. 23 is a structural schematic diagram of a shielding structure, an anode and a touch electrode according to an embodiment of the present disclosure;

FIG. 24 is still another structural schematic diagram of a display panel according to an embodiment of the present disclosure;

FIG. 25 is still another structural schematic diagram of a display panel according to an embodiment of the present disclosure;

FIG. 26 is still another structural schematic diagram of a display panel according to an embodiment of the present disclosure;

FIG. 27 is still another partial structural schematic diagram of a display panel according to an embodiment of the present disclosure;

FIG. 28 is a schematic diagram of still another film layer structure of a display panel according to an embodiment of the present disclosure;

FIG. 29 is still another structural schematic diagram of a display panel according to an embodiment of the present disclosure; and

FIG. 30 is a structural schematic diagram of a display apparatus according to an embodiment of the present disclosure.

### DESCRIPTION OF EMBODIMENTS

In order to better understand technical solutions of the present disclosure, embodiments of the present disclosure are described in detail below in conjunction with the drawings.

It should be clear that the described embodiments are merely a part of the embodiments of the present disclosure rather than all of the embodiments. All other embodiments obtained by those of skill in the art without creative efforts based on the embodiments of the present disclosure shall fall within the scope of protection of the present disclosure.

The terms used in the embodiments of the present disclosure are only for the purpose of describing specific embodiments and are not intended to limit the present disclosure. The singular forms “a/an”, “said” and “the” used in the embodiments of the present disclosure and the appended claims are also intended to include the plural forms, unless the context clearly indicates otherwise.

It should be understood that the term “and/or” used herein is only a description of the correlation relationship between associated objects, indicating that there can be three relationships. For example, A and/or B can mean: A exists alone, A and B exist simultaneously, and B exists alone. In addition, the character “/” herein generally indicates that the associated objects before and after the character are in an “or” relationship.

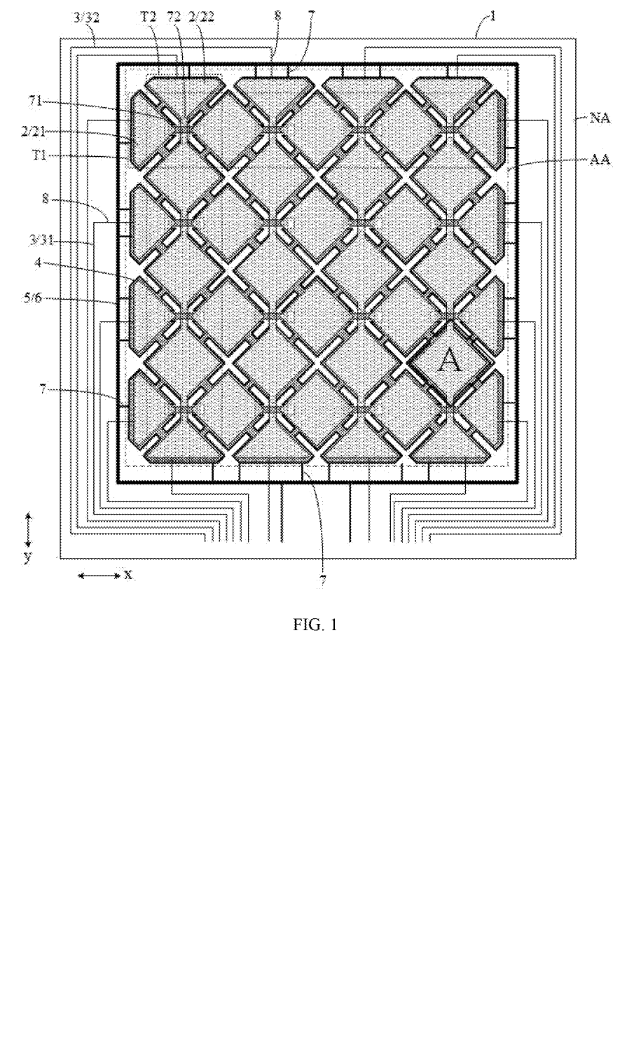

An embodiment of the present disclosure provides a display panel, as shown in FIG. 1, which is a structural schematic diagram of a display panel according to an embodiment of the present disclosure, the display panel includes a display region AA and a non-display region NA surrounding the display region AA.

The display panel further includes a substrate 1.

The display panel further includes a touch electrode 2 and a touch line 3. The touch electrode 2 is at least located in the display region AA, and the touch line 3 is electrically connected to the touch electrode 2 and located in the non-display region NA.

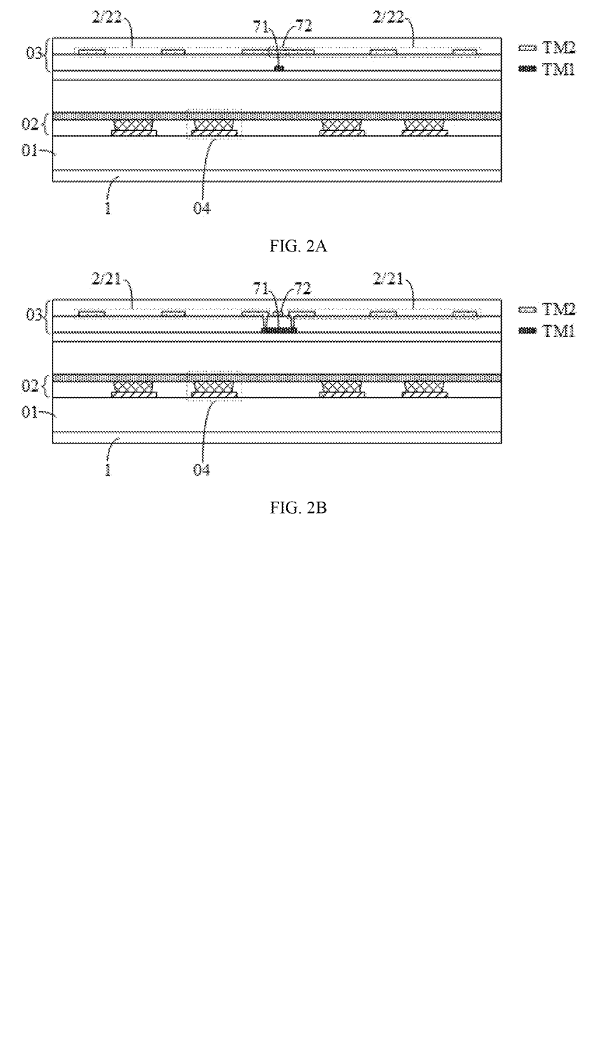

Regarding the film layer position of the touch electrode 2, in one arrangement, as shown in FIGS. 2A and 2B, where FIG. 2A is a schematic diagram of a film layer structure of a display panel according to an embodiment of the present disclosure, and FIG. 2B is a schematic diagram of another film layer structure of a display panel according to an embodiment of the present disclosure, an array layer 01, a light-emitting device layer 02, and a touch layer 03 that are stacked are disposed at a side of the substrate 1. The array layer 01 includes a pixel circuit (not shown), the light-emitting device layer 02 includes a light-emitting element 04, and the touch layer 03 includes the touch electrode 2.

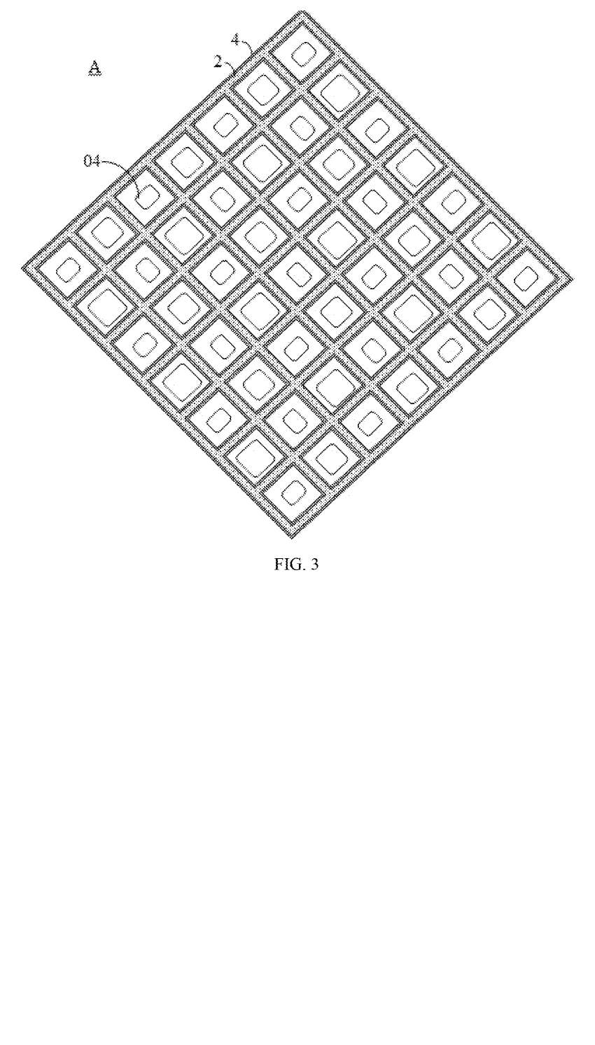

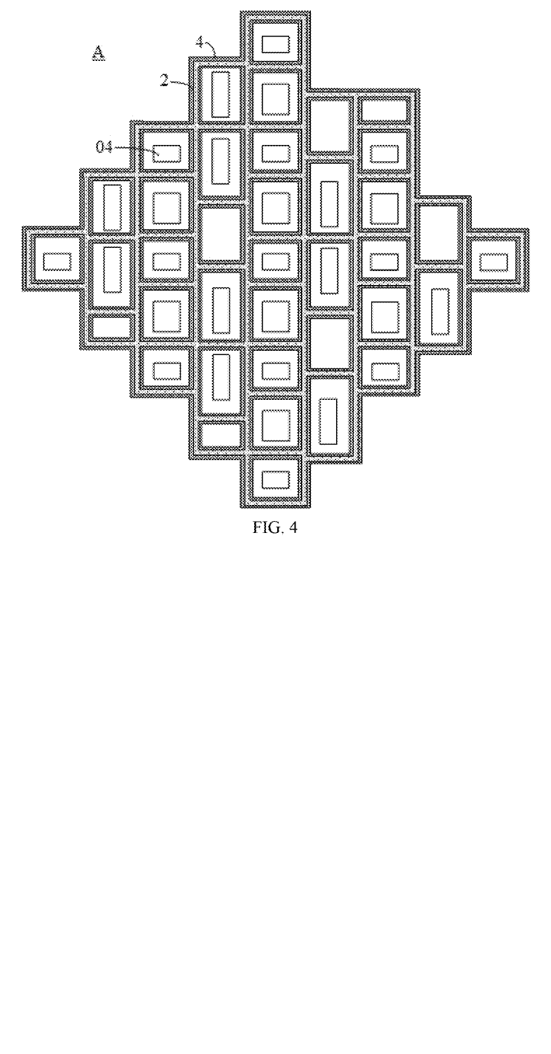

Regarding a specific structure of the touch electrode 2, in one arrangement, in conjunction with FIGS. 1, 3, and 4, where FIG. 3 is an enlarged structural schematic diagram of a region A in FIG. 1, and FIG. 4 is another enlarged structural schematic diagram of the region A in FIG. 1, the touch electrode 2 is a grid structure, and its mesh opening exposes the light-emitting element 04 to avoid blocking the light out of the light-emitting element 04. The grid shape of the touch electrode 2 may be related to the shape, arrangement, etc., of the light-emitting element 04.

More specifically, referring to FIG. 1, the touch electrode 2 includes a first touch electrode 21 and a second touch electrode 22. Among a plurality of first touch electrodes 21 arranged in a first direction x, adjacent first touch electrodes 21 are electrically connected to each other by a first connection portion 71. Among a plurality of second touch electrodes 22 arranged in a second direction y, adjacent second touch electrodes 22 are electrically connected to each other by a second connection portion 72. The second connection portion 72 and the first connection portion 71 are arranged in a crossed and insulated manner. The first direction x intersects with the second direction y.

The plurality of first touch electrodes 21 arranged in the first direction x and sequentially connected by a plurality of first connection portions 71 constitute a first touch structure T1, and the plurality of second touch electrodes 22 arranged in the second direction y and sequentially connected by a plurality of second connection portions 72 constitute a second touch structure T2. One of the first touch structure T1 and the second touch structure T2 is a touch sensing structure, and the other is a touch driving structure. The first touch structure T1 and the second touch structure T2 cooperate to achieve a touch function.

In conjunction with FIGS. 2A and 2B, the touch layer 03 includes a touch bridge layer TM1 and a touch metal layer TM2, and the touch bridge layer TM1 is located at a side of the touch metal layer TM2 close to the substrate 1. The touch electrode 2 is located in the touch metal layer TM2. One of the first connection portion 71 and the second connection portion 72 is located in the touch bridge layer TM1, and the other is located in the touch metal layer TM2. FIGS. 2A and 2B illustrate an example where the first connection portion 71 is located in the touch bridge layer TM1 and the second connection portion 72 is located in the touch metal layer TM2.

Accordingly, the touch line 3 may specifically include a first touch line 31 electrically connected to the first touch electrode 21, and a second touch line 32 electrically connected to the second touch electrode 22.

The display panel further includes a shielding structure 4 and a shielding trace 5.

The shielding structure 4 is located between the substrate 1 and the touch electrode 2, for example, may be located between the touch metal layer TM2 and the array layer 01. The shielding structure 4 overlaps with the touch electrode 2 in a direction perpendicular to a plane of the substrate.

Referring to FIGS. 3 and 4, the shielding structure 4 may also be a grid structure. A mesh opening of the shielding structure 4 exposes the light-emitting element 04. Grid traces of the shielding structure 4 overlap with grid traces of the touch electrode 2 in the direction perpendicular to the plane of the substrate 1. Widths of the grid traces in the shielding structure 4 may be the same as or different from widths of the grid traces in the touch electrode 2. In an embodiment of the present disclosure, in order to achieve a better shielding effect, the widths of the grid traces in the shielding structure 4 may be set to be greater than the widths of the grid traces in the touch electrode 2.

The shielding trace 5 includes a first shielding line 6. The first shielding line 6 is located in the non-display region NA and at least partially surrounds the display region AA. The first shielding line 6 is electrically connected to the shielding structure 4.

In an embodiment of the present disclosure, the touch electrode 2 can be configured to detect a touch operation of a touch tool such as an active stylus, or can be configured to detect a touch operation of a finger of a user. In one driving mode, the touch operation of the touch tool and the touch operation of the finger of the user are detected in a time-division manner.

In the technical solution according to the embodiment of the present disclosure, the shielding structure 4 is disposed below the touch electrode 2, and the shielding structure 4 can be configured to shield a display signal and display noise, and in turn weaken the interference of the display noise on a touch function signal. For example, the shielding structure 4 may weaken the interference of the display signal and display noise on a touch signal on the touch electrode 2. Or, when a touch tool such as an active stylus is used to control the display panel, the touch tool communicates and interacts with the touch electrode 2, and the shielding structure 4 can also weaken the interference of the display signal and display noise on a signal emitted by the touch tool.

Further, in the embodiment of the present disclosure, the first shielding line 6 is further provided for providing a shielding signal to the shielding structure 4. The first shielding line 6 surrounds the display region AA, and in turn the shielding structure 4 can establish connections with the first shielding line 6 at a plurality of positions. For example, in four bezels (upper, lower, left, and right), the shielding structure 4 is connected to the first shielding line 6, to significantly improve the uniformity of the shielding signal in the display region AA, and especially a better shielding effect can be achieved in medium and large-sized display panels, to improve the touch performance to a greater extent.

In a feasible implementation, referring to FIG. 1 again, the first shielding line 6 is located at a side of the touch line 3 close to the display region AA.

The first shielding line 6 is disposed between the touch line 3 and the display region AA. On one hand, the first shielding line 6 can be used to shield the signal or noise in the display region AA from interfering a signal on the touch line 3. On the other hand, the first shielding line 6 is closer to the shielding structure 4, making it easier to establish a connection between the first shielding lines 6 and the shielding structure 4.

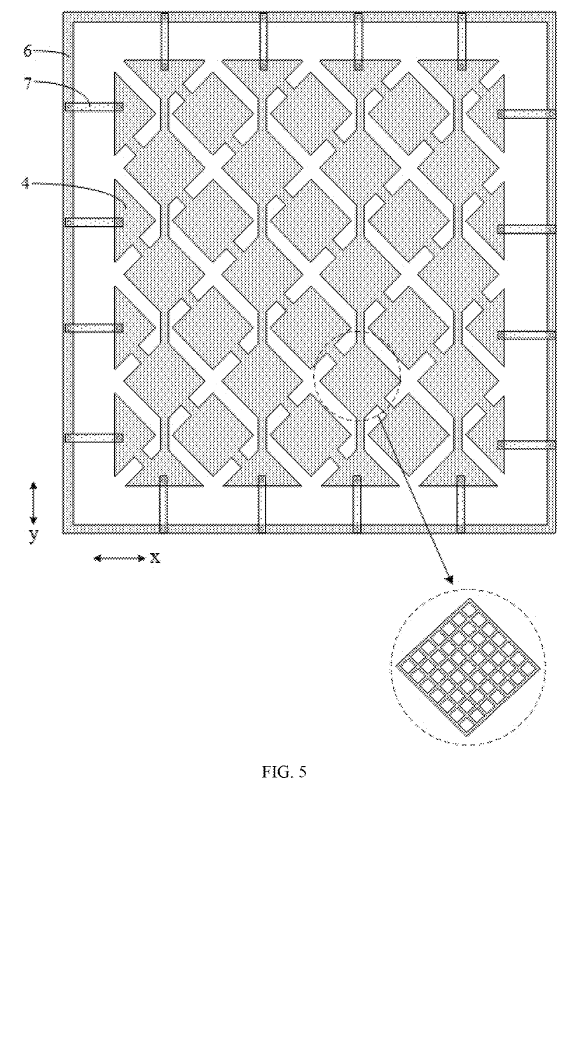

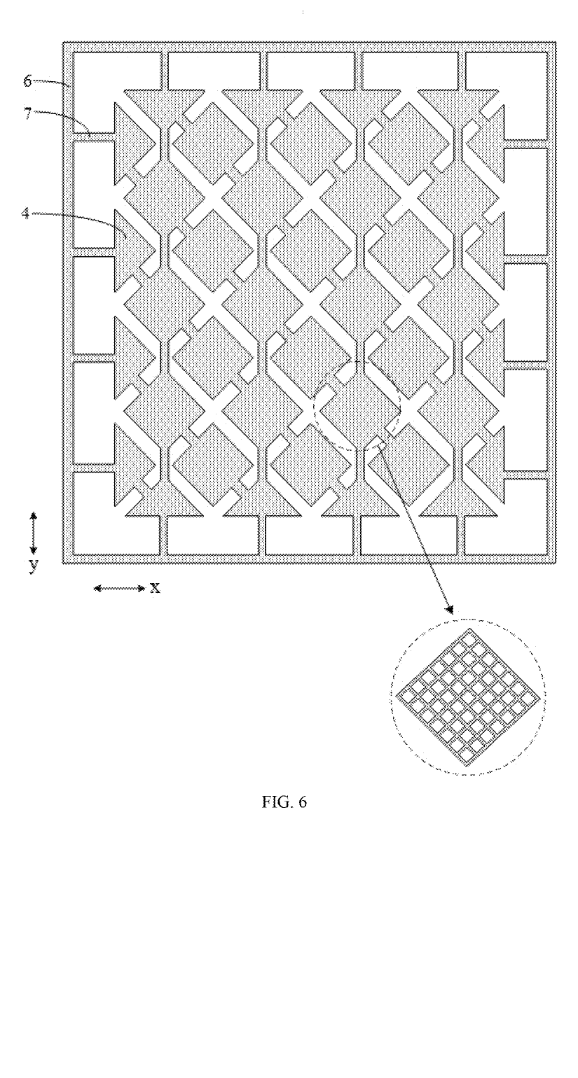

In a feasible implementation, referring to FIGS. 5 and 6, the shielding structure 4 is connected to the first shielding line 6 through a first connection line 7.

In an arrangement, as shown in FIGS. 5 and 6, where FIG. 5 is a schematic diagram of a connection between a shielding structure and a first shielding line according to an embodiment of the present disclosure, and FIG. 6 is a schematic diagram of another connection between a shielding structure and a first shielding line according to an embodiment of the present disclosure, the number of first connection lines 7 can be multiple, and there is an interval between adjacent first connection lines 7. In this structure, a plurality of shielding signal access points spaced apart from one another are established between the shielding structure 4 and the first shielding line 6, which can improve the uniformity of the shielding signal at different positions of the shielding structure 4. Referring to FIG. 5, the first connection line 7 can be disposed in a different layer from at least one of the shielding structure 4 and the first shielding line 6, and the first connection line 7 is electrically connected to the shielding structure 4 and/or the first shielding line 6, which are located in a different layer from the first connection line 7, through via-holes. Or, referring to FIG. 6, the first connection line 7 can also be disposed in a same layer as at least one of the shielding structure 4 and the first shielding line 6, and the first connection line 7 is in direct communication with the shielding structure 4 and/or the first shielding line 6, which are located in the same layer as the first connection line 7, so as to realize an electrical connection.

When the shielding structure 4 is electrically connected to the first shielding line 6 through a plurality of first connection lines 7, in order to further improve the uniformity of the shielding signal, referring to FIGS. 5 and 6 again, the plurality of shielding signal access points spaced apart from one another can be distributed at equal intervals in the non-display region NA at one side of the display region AA. That is, among multiple first connection lines 7 arranged in a same direction, a distance between adjacent first connection lines 7 is equal.

In a feasible implementation, referring to FIG. 1 again, the touch electrode 2 is connected to the touch line 3 through a second connection line 8. The second connection line 8 electrically connected to the first touch electrode 21 extends in the first direction x, and the second connection line 8 electrically connected to the second touch electrode 22 extends in the second direction y.

It can be understood that the non-display region NA includes four bezels, i.e., an upper bezel, a lower bezel, a left bezel, and a right bezel.

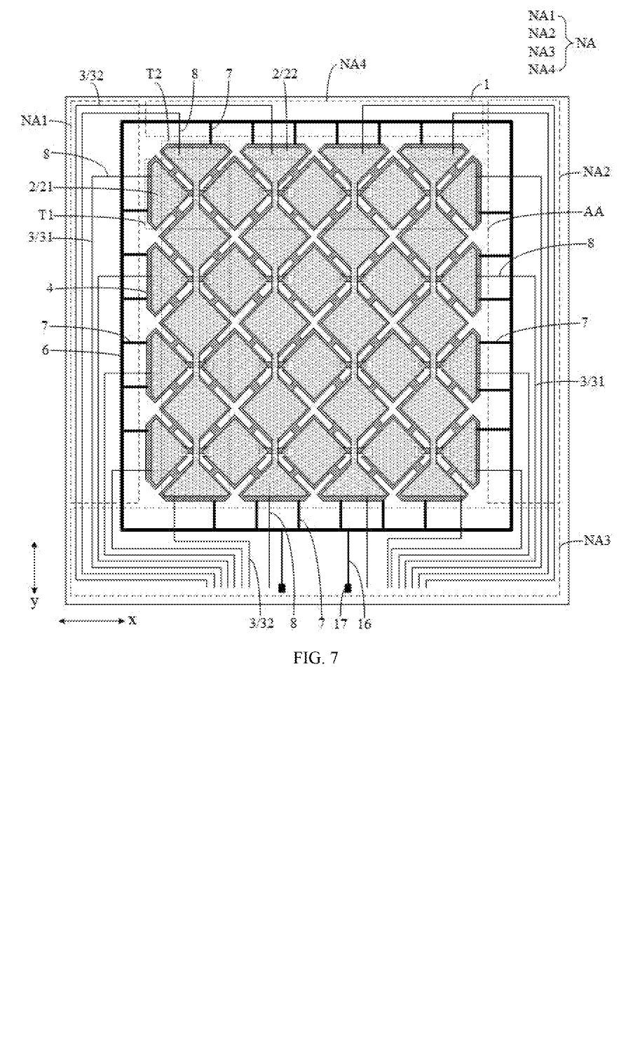

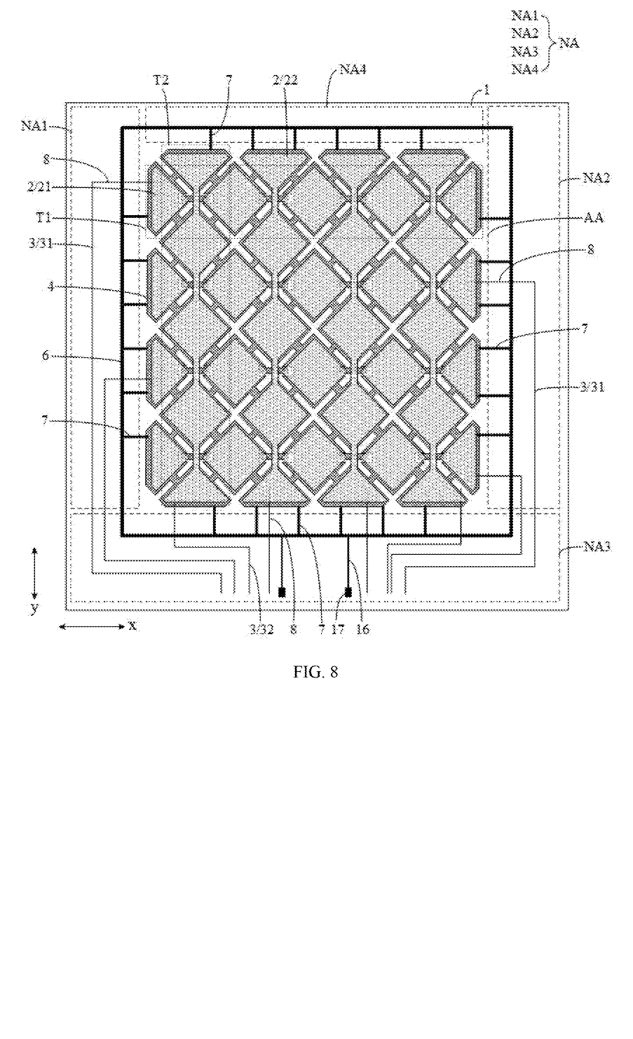

Referring to FIGS. 7 and 8, the non-display region NA includes a first non-display region NA1 and a second non-display region NA2 located at two opposite sides of the display region AA in the first direction x. One of the first non-display region NA1 and the second non-display region NA2 is the left bezel, and the other is the right bezel.

The non-display region NA further includes a third non-display region NA3 and a fourth non-display region NA4 at opposite sides of the display region AA in the second direction y. In an embodiment of the present disclosure, the shielding trace 5 is connected to a first lead 16 in the third non-display region NA3, and the first lead 16 is further connected to a pin 17, e.g., it means that the third non-display region NA3 is the lower bezel, and the fourth non-display region NA4 is the upper bezel.

Regarding the connection manner between the touch electrode 2 and the second connection line 8, in one connection manner, as shown in FIG. 7, which is yet another structural schematic diagram of a display panel according to an embodiment of the present disclosure, the touch structure adopts a “2T2R” design. The first touch structure T1 is connected to the first touch line 31 through the second connection line 8 in the first non-display region NA1 and the second non-display region NA2, respectively; and the second touch structure T2 is connected to the second touch line 32 through the second connection line 8 in the third non-display region NA3 and the fourth non-display region NA4, respectively.

Or, in another connection manner, as shown in FIG. 8, which is yet another structural schematic diagram of a display panel according to an embodiment of the present disclosure, the touch structure adopts a “1T1R” design. A part of the first touch structures T1 each are connected to the first touch line 31 through the second connection line 8 in the first non-display region NA1, while the remaining first touch structures T1 each are connected to the first touch line 31 through the second connection line 8 in the second non-display region NA2; and the second touch structures T2 each are connected to the second touch line 32 through the second connection line 8 in the third non-display region NA3.

In an embodiment of the present disclosure, the second connection line 8 and the first connection line 7 are disposed in a same layer or in different layers.

The second connection line 8 and the first connection line 7 are both located in the non-display region NA. When the second connection line 8 and the first connection line 7 are located in the same layer, the two types of connection lines occupy only one metal layer, and by making the positions of the two avoid each other, short circuits can be avoided, which can save the number of film layers. When the second connection line 8 and the first connection line 7 are located in different layers, the coupling between the two is relatively small, which can reduce the influence on the shielding signal when the touch signal jumps, thereby improving the stability of the shielding signal. Further, when the second connection line 8 and the first connection line 7 are arranged in different layers, the second connection line 8 and the first connection line 7 do not overlap with each other in the direction perpendicular to the plane of the substrate 1.

In a feasible implementation, referring to FIGS. 7 and 8 again, m first connection lines 7 are disposed between adjacent second connection lines 8, where m is an integer greater than or equal to 1.

For example, when the touch structure adopts the “2T2R” design, referring to FIG. 7, the shielding structure 4 is connected to the first shielding line 6 through multiple first connection lines 7 in each of the first non-display region NA1, the second non-display region NA2, the third non-display region NA3 and the fourth non-display region NA4, and m first connection lines 7 are disposed between adjacent second connection lines 8 in these four non-display regions.

When the touch structure adopts the “1T1R” design, referring to FIG. 8, the shielding structure 4 is connected to the first shielding line 6 through multiple first connection lines 7 at least in each of the first non-display region NA1, the second non-display region NA2 and the third non-display region NA3, and m first connection lines 7 are disposed between adjacent second connection lines 8 in these three non-display regions. Further, the shielding structure 4 may also be connected to the first shielding line 6 through multiple first connection lines 7 in the fourth non-display region NA4, and the number of the first connection lines 7 and the interval between the first connection lines 7 in the fourth non-display region NA4 may be kept consistent with the number of the first connection lines 7 and the interval between the first connection lines 7 in the third non-display region NA3.

When m first connection lines 7 are disposed between adjacent second connection lines 8, it means that the shielding signal access points and touch signal access points are distributed periodically. The distribution design of the shielding signal access points is more regular, which is conducive to improving the uniformity of the shielding signal in the display region AA.

In a feasible implementation, m ≥ 2. That is, at least two first connection lines 7 are disposed between adjacent second connection lines 8. In this way, with a larger number of the first connection lines 7, the shielding structure 4 can be connected to the first shielding line 6 at more positions, and the uniformity of the shielding signal in the display region AA is better.

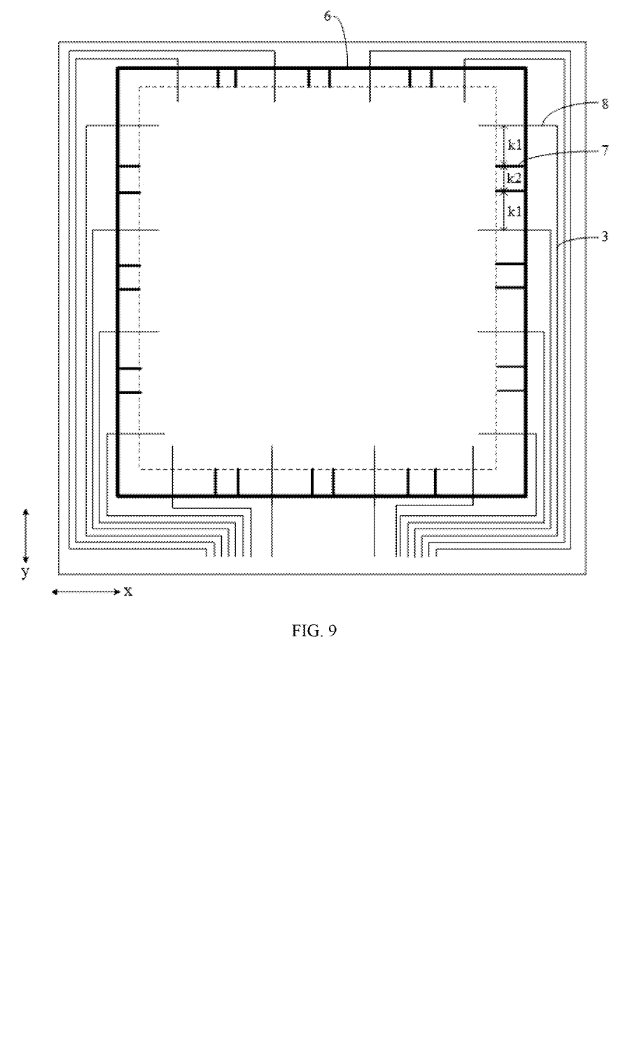

When m ≥ 2, further, as shown in FIG. 9, which is still another structural schematic diagram of a display panel according to an embodiment of the present disclosure, a distance between the second connection line 8 and the first connection line 7 adjacent thereto is a first distance k1. Among the m first connection lines 7 between the adjacent second connection lines 8, a distance between adjacent first connection lines 7 is a second distance k2, and the first distance k1 is greater than the second distance k2.

The first connection line 7 is configured to transmit the shielding signal, and the second connection line 8 is configured to transmit the touch signal. These two types of signals are different. Increasing the distance between the second connection line 8 and the first connection line 7 can be conducive to reducing the coupling between the two, so that even if the second connection line 8 and the first connection line 7 are located in the same layer, no significant coupling will occur.

In an embodiment of the present disclosure, the first shielding line 6 may adopt a double-layer wiring design to make the first shielding line 6 have a smaller load, which in turn reduces attenuation, delay, etc. of the shielding signal during transmission.

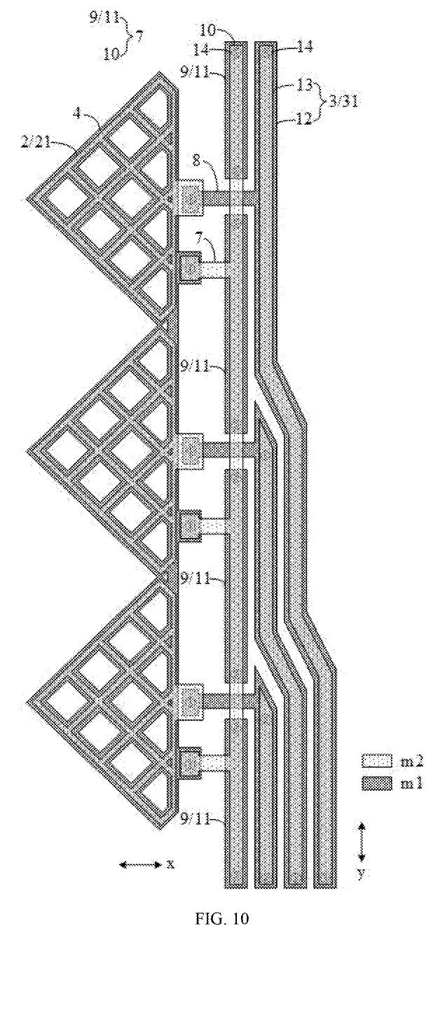

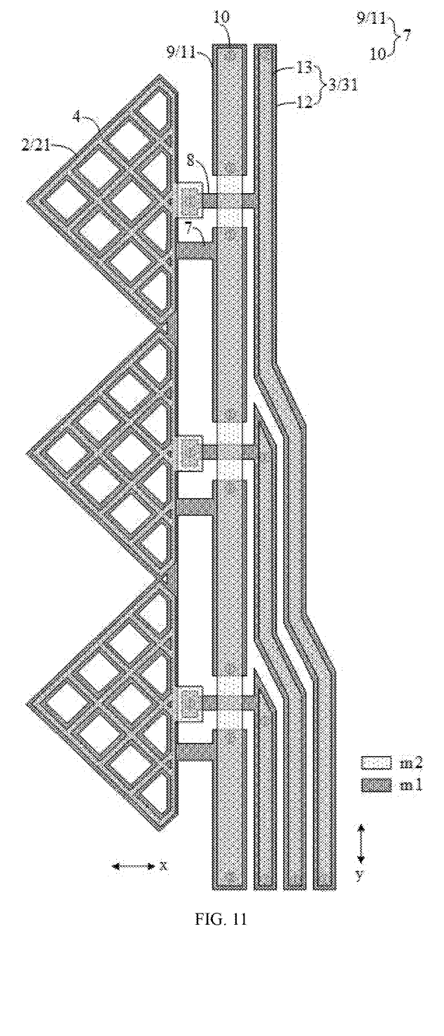

When the first shielding line 6 adopts the double-layer wiring design, in a feasible implementation, as shown in FIGS. 10 and 11, where FIG. 10 is a partial structural schematic diagram of a display panel according to an embodiment of the present disclosure, and FIG. 11 is another partial structural schematic diagram of a display panel according to an embodiment of the present disclosure, the first shielding line 6 includes a first shielding sub-line 9 and a second shielding sub-line 10 that are disposed in different layers and electrically connected to each other, and the first shielding sub-line 9 overlaps with the second shielding sub-line 10 in the direction perpendicular to the plane of the substrate 1.

The second connection line 8 and the first shielding sub-line 9 are located in a first metal layer m1, and the second shielding sub-line 10 is located in a second metal layer m2. Moreover, the first shielding sub-line 9 includes a plurality of first segments 11 spaced apart from one another. Each of the first segments 11 is electrically connected to the second shielding sub-line 10. The second connection line 8 is disposed between adjacent first segments 11.

As described above, the first shielding line 6 being located between the touch line 3 and the display region AA can shield the interference of the display signal and the display noise on the signal on the touch line 3. When the first shielding line 6 is located inside the touch line 3, the second connection line 8 may overlap with the first shielding line 6. To this end, when the second connection line 8 and the first shielding sub-line 9 are disposed in the same layer, the first shielding sub-line 9 can be designed to include the plurality of first segments 11 spaced apart from one another, so that the second connection line 8 extends from an interval between adjacent first segments 11 to connect to the touch line 3 on the outer side, thereby realizing the avoidance of the second connection line 8 by the first shielding sub-line 9.

Further, referring to FIG. 11, the first connection line 7 may be located in the first metal layer m1 and in direct communication with the first segment 11. Or, referring to FIG. 10, the first connection line 7 may also be located in the second metal layer m2 and in direct communication with the second shielding sub-line 10. When the first connection line 7 is located in the second metal layer m2, the first connection line 7 and the second connection line 8 are disposed in different layers, and the coupling between the two is smaller.

In one structure, in conjunction with FIGS. 2 and 10, the first metal layer m1 may be a touch bridge layer TM1, and the second metal layer m2 may be a touch metal layer TM2. That is to say, the second shielding sub-line 10 and the touch electrode 2 are located in a same layer, and the first shielding sub-line 9 and a bridge in the touch structure are located in a same layer, thereby achieving reasonable utilization of the metal layers.

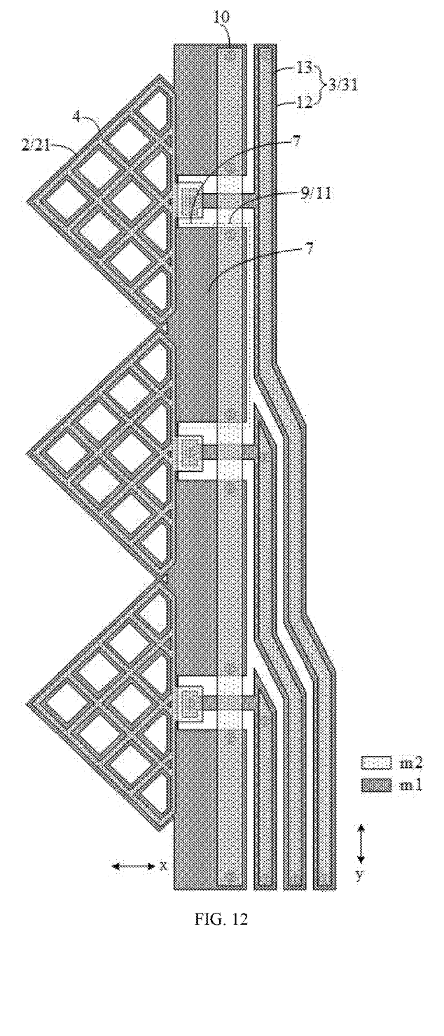

In a feasible implementation, as shown in FIG. 12, which is yet another partial structural schematic diagram of a display panel according to an embodiment of the present disclosure, the first connection line 7 and the shielding structure 4 are located in the first metal layer m1, and the shielding structure 4, the first connection line 7 and the first segment 11 are in communication with each other.

In an arrangement direction of the first segments 11, a length of the first connection line 7 is equal to a length of the first segment 11. In particular, in the first non-display region NA1 and the second non-display region NA2, the length of the first connection line 7 is equal to the length of the first segment 11 in the second direction y; and in the third non-display region NA3 and the fourth non-display region NA4, the length of the first connection line 7 is equal to the length of the first segment 11 in the first direction x. Therefore, on the premise that the first connection line 7 avoids the second connection line 8, the connection area between the first connection line 7 and the shielding structure 4 is increased as much as possible, thereby optimizing the transmission effect of the shielding signal.

Moreover, in the direction perpendicular to the plane of the display panel, at least a part of the first connection line 7 does not overlap with the touch electrode 2 and the second shielding sub-line 10. When the first connection line 7 and the first segment 11 are located in the same layer and the length of the first connection line 7 is equal to the length of the first segment 11, the first connection line 7 and the first segment 11 connected to each other form a planar metal. In the planar metal, at least a part overlapping the second shielding sub-line 10 may be classified as the first segment 11, and the remaining part may be classified as the first connection line 7. That is, at least a part of the first connection line 7 does not overlap with both the touch electrode 2 and the second shielding sub-line 10.

In an embodiment of the present disclosure, the touch line 3 may also adopt a double-layer wiring design, to make the touch line 3 have a smaller load, thereby reducing attenuation, delay, etc. of the touch signal during transmission.

In a feasible implementation, referring to FIGS. 10 and 11, the touch line 3 includes a first touch sub-line 12 and a second touch sub-line 13 that are located in different layers and electrically connected to each other, and in the direction perpendicular to the plane of the substrate 1, the first touch sub-line 12 overlaps with the second touch sub-line 13. The first touch sub-line 12 is located in the first metal layer m1, and the second touch sub-line 13 is located in the second metal layer m2.

That is, the two wiring layers of the touch line 3 and the two wiring layers of the shielding line are located in the same two metal layers. In this case, these two types of double-layer traces occupy a smaller number of film layers.

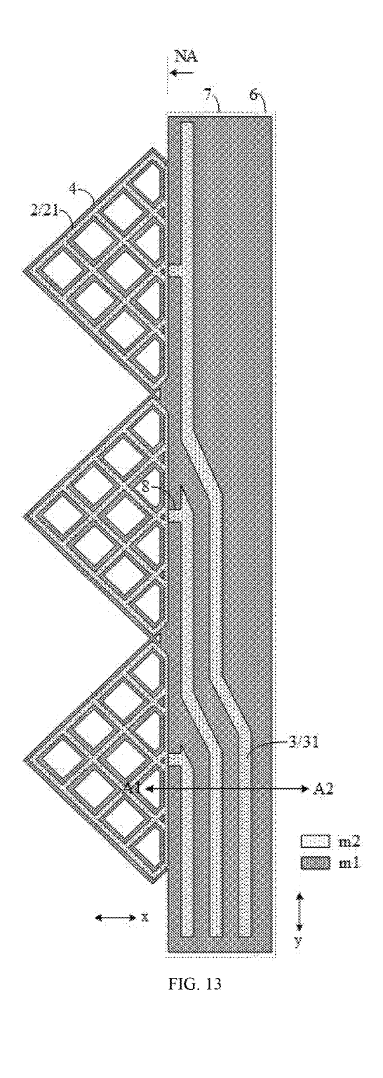

In a feasible implementation, referring to FIGS. 10 and 13, the first connection line 7 and the second connection line 8 are located in different layers, to reduce the coupling between the two and improve the stability of the shielding signal. Further, the first connection line 7 and the first shielding line 6 are at least partially located in a same layer, and the second connection line 8 and the touch line 3 are at least partially located in a same layer, thereby reducing the number of film layers required to be occupied by these traces and thus optimizing the film layer design.

It should be noted that “the first connection line 7 and the first shielding line 6 are at least partially located in a same layer” includes at least the following three cases: I. referring to FIG. 13, the first connection line 7 and the first shielding line 6 each are a single-layer trace, and they are located in a same layer; II. referring to FIG. 10, the first shielding line 6 adopts the double-layer wiring design, and the first connection line 7 and one layer of the two wiring layers are located in a same layer; and III. the first connection line 7 and the first shielding line 6 each adopt the double-layer wiring design, and two layers of traces are located in a same layer respectively.

Similarly, “the second connection line 8 and the touch line 3 are at least partially located in a same layer” includes at least the following three cases: I. referring to FIG. 13, the second connection line 8 and the touch line 3 each are a single-layer trace, and they are located in a same layer; II. referring to FIG. 10, the touch line 3 adopts the double-layer wiring design, and the second connection line 8 and one layer of the two wiring layers are located in a same layer; and III. the second connection line 8 and the touch line 3 each adopt the double-layer wiring design, and two layer of traces are located in a same layer respectively.

In a feasible implementation, referring to FIG. 10 again, the first shielding line 6 and the touch line 3 may each adopt a double-layer wiring design, and two wiring layers of each of the first shielding line 6 and the touch line 3 are electrically connected to each other through a via-hole 14. Such a double-layer structure can make the first shielding line 6 and the touch line 3 each have a smaller load, thereby reducing the voltage drop, delay, e.g. of each of the shielding signal and the touch signal during the transmission.

Further, the first connection line 7 and the second connection line 8 may each adopt a single-layer wiring design, the first connection line 7 and one layer of the two wiring layers of the first shielding line 6 are located in a same layer, and the second connection line 8 and one layer of the two wiring layers of the touch line 3 are located in a same layer. For example, referring to FIG. 10 again, the first connection line 7 and the second shielding sub-line 10 are located in a same layer, and the second connection line 8 and the first touch sub-line 12 are located in a same layer.

In a feasible implementation, as shown in FIG. 13, which is still another partial structural schematic diagram of a display panel according to an embodiment of the present disclosure, in the non-display region NA located at a side of the display region AA, in a direction intersecting with an arrangement direction of a plurality of second connection lines 8, a length of the first connection line 7 is greater than a distance between two adjacent second connection lines 8.

For example, when the touch structure adopts the “2T2R” design, in the first non-display region NA1 and the second non-display region NA2, in the second direction y, the length of the first connection line 7 is greater than the distance between two adjacent second connection lines 8. In the third non-display region NA3 and the fourth non-display region NA4, in the first direction x, the length of the first connection line 7 is greater than the distance between two adjacent second connection lines 8.

In this structure, the length of the first connection line 7 in an extending direction of the non-display region where it is located is longer. In an arrangement, at least two first connection lines 7 are disposed in each of the first non-display region NA1, the second non-display region NA2, the third non-display region NA3 and the fourth non-display region NA4, and there is an interval between adjacent first connection lines 7. Or, in another arrangement, one first connection line 7 is provided in each of the first non-display region NA1, the second non-display region NA2, the third non-display region NA3 and the fourth non-display region NA4, and these four first connection lines 7 are sequentially connected end to end to form a continuous trace.

This structure can allow for a larger connection area between the shielding structure 4 and the first shielding line 6, resulting in better uniformity of the shielding signal. Moreover, in this structure, the shielding structure 4, the first connection line 7 and the first shielding line 6 can be further arranged in a same layer and in communication with each other, for example, all three are located in the touch bridge layer TM1 or in an anode layer in the light-emitting device layer 02. Further, the touch electrode 2, the second connection line 8 and the touch line 3 are arranged in a same layer and in communication with each other, for example, all three are located in the touch metal layer TM2 to simplify wiring.

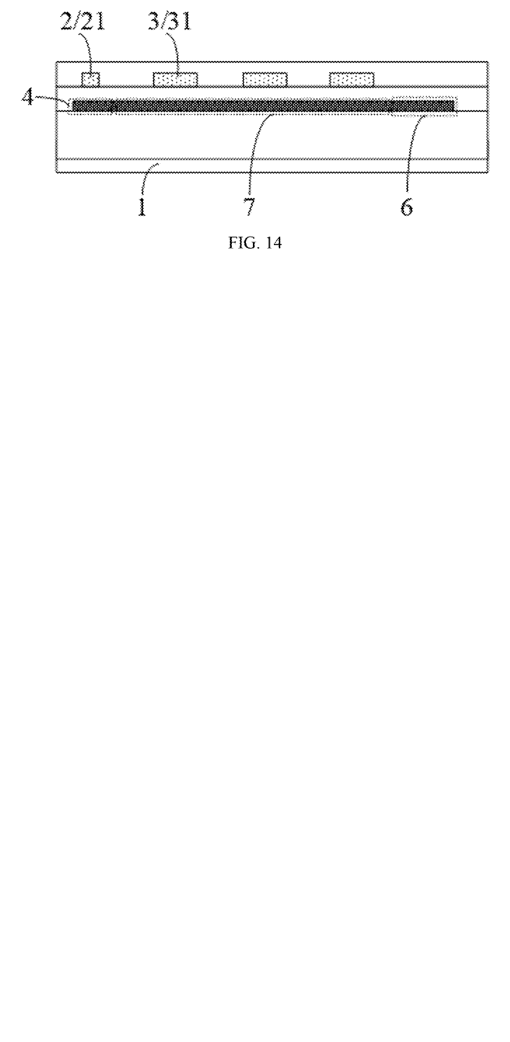

In a feasible implementation, with reference to FIGS. 13 and 14, where FIG. 14 is a sectional view in a direction A1-A2 in FIG. 13, at least a part of the first connection line 7 is located at a side of the first connection line 7 away from the substrate 1. In the direction perpendicular to the plane of the substrate 1, the first connection line 7 overlaps with the touch line 3, thereby shielding the influence of the underlying display signal and display noise on the touch signal on the touch line 3.

Further, in conjunction with FIG. 1, the touch electrode 2 includes a first touch electrode 21 and a second touch electrode 22. Among a plurality of first touch electrodes 21 arranged in a first direction x, adjacent first touch electrodes 21 are electrically connected to each other by a first connection portion 71; and among a plurality of second touch electrodes 22 arranged in a second direction y, adjacent second touch electrodes 22 are electrically connected by a second connection portion 72. The second connection portion 72 and the first connection portion 71 are arranged in a crossed and insulated manner. The first direction x intersects with the second direction y.

The touch line 3 is located in a same layer as the touch electrode 2. Further, the second connection line 8 is also located in a same layer as the touch electrode 2. The second connection line 8, the touch line 3 and the touch electrode 2 are directly in communication with each other to realize connection without the need for punching, thereby realizing higher connection reliability.

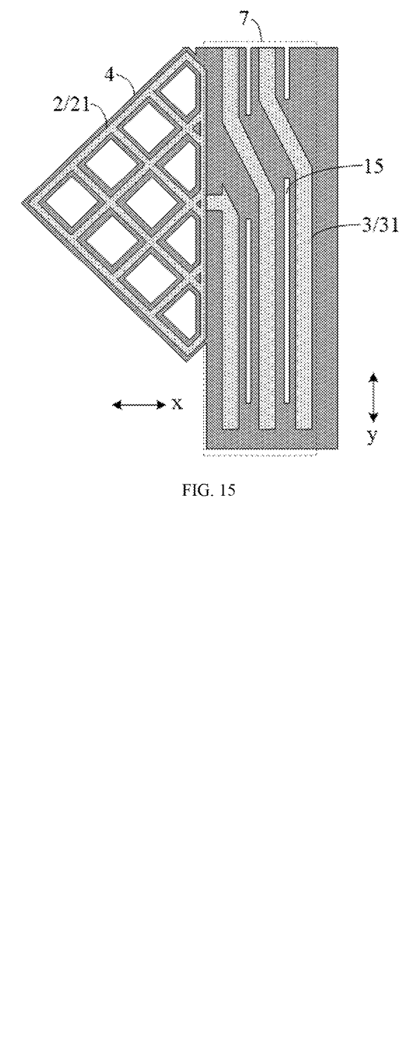

In a feasible implementation, as shown in FIG. 15, which is yet another partial structural schematic diagram of a display panel according to an embodiment of the present disclosure, the first connection line 7 can also be designed in a patterned manner, with some hollows 15 provided in the first connection line 7. To better ensure the shielding effect of the first connection line 7 on the touch line 3, in the direction perpendicular to the plane of the substrate 1, the hollows 15 may not overlap with the touch line 3.

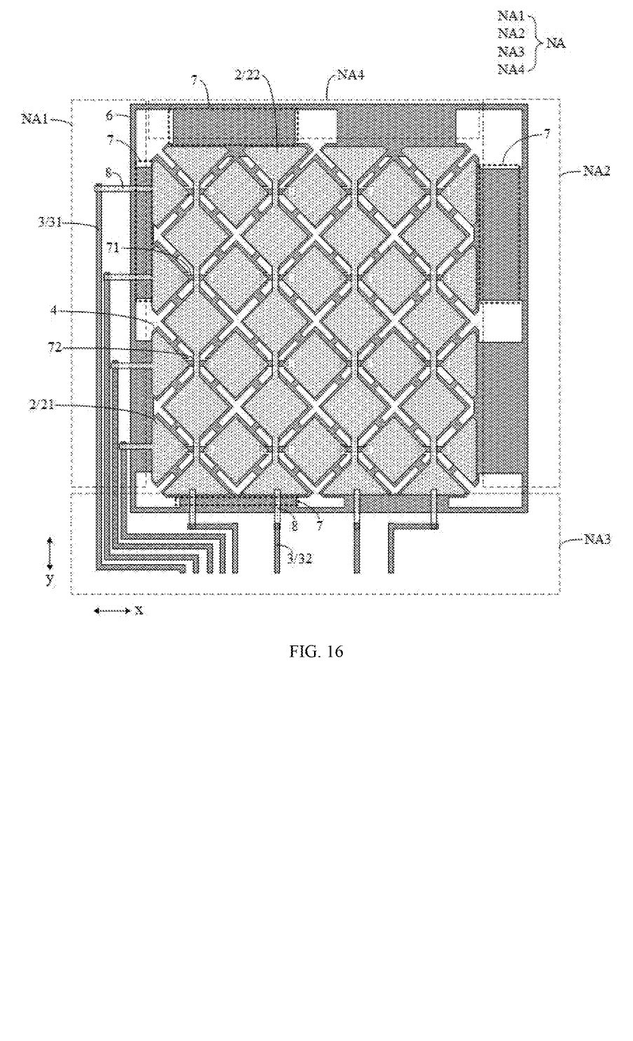

In a possible implementation, as shown in FIG. 16, which is still another structural schematic diagram of a display panel according to an embodiment of the present disclosure, the non-display region NA includes a first non-display region NA1 and a second non-display region NA2 located at two opposite sides of the display region AA in a first direction x, and a third non-display region NA3 and a fourth non-display region NA4 located at two opposite sides of the display region AA in a second direction y, and the first direction x intersects with the second direction y.

The touch electrode 2 includes a first touch electrode 21 and a second touch electrode 22. Among a plurality of first touch electrodes 21 arranged in the first direction x, adjacent first touch electrodes 21 are electrically connected by a first connection portion 71; and among a plurality of second touch electrodes 22 arranged in the second direction y, adjacent second touch electrodes 22 are electrically connected by a second connection portion 72. The second connection portion 72 and the first connection portion 71 are arranged in a crossed and insulated manner.

The first touch electrode 21 is electrically connected to the touch line 3 through the second connection line 8 in the first non-display region NA1. The second touch electrode 22 is electrically connected to the touch line 3 through the second connection line 8 in the third non-display region NA3.

The first shielding line 6 is located at a side of the touch line 3 close to the display region AA. The touch line 3 and the first shielding line 6 are located in a same layer. The second connection line 8 and the first shielding line 6 are located in different layers.

In the first direction x, a total width of the first shielding line 6 and the first connection line 7 in the first non-display region NA1 is less than a total width of the first shielding line 6 and the first connection line 7 in the third non-display region NA3; and/or in the second direction y, a total width of the first shielding line 6 and the first connection line 7 in the third non-display region NA3 is less than a total width of the first shielding line 6 and the first connection line 7 in the fourth non-display region NA4.

Taking the first non-display region NA1 and the second non-display region NA2 as an example, the first touch line 31 connected to the first touch electrode 21 is located in the first non-display region NA1, and since the first touch line 31 is located in a same layer as the first shielding line 6 and the first connection line 7, a width of the first connection line 7 in the first non-display region NA1 and a width of the first connection line 7 in the second non-display region NA2 can be designed differently. That is to say, the total widths of the first shielding line 6 and the first connection line 7 are designed differently, and by setting the total width of the first shielding line 6 and the first connection line 7 in the first non-display region NA1 to be smaller, some space can be vacated to accommodate the first touch line 31.

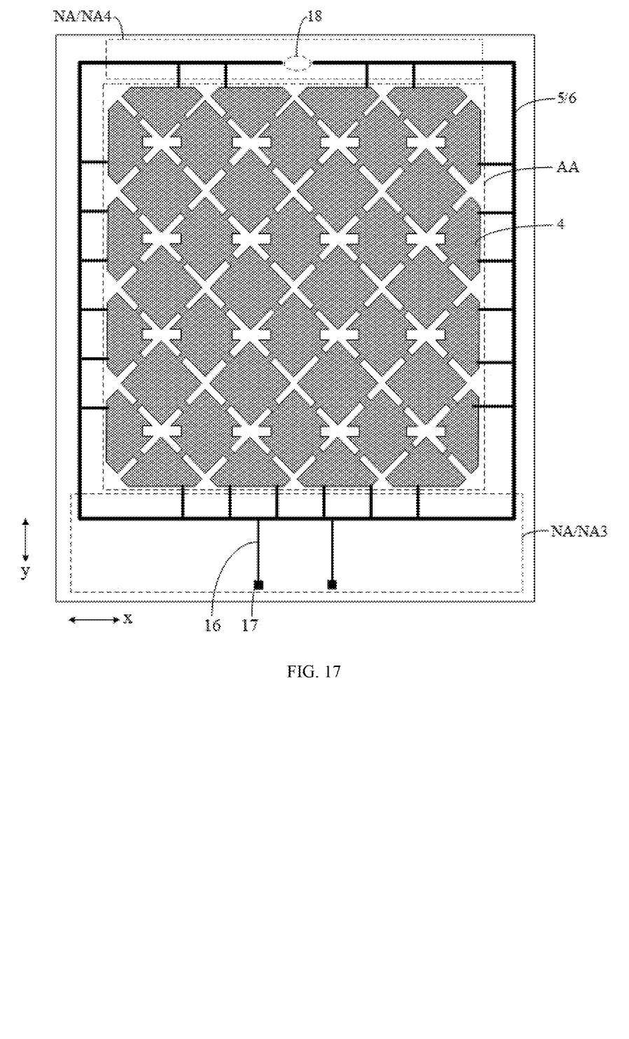

In a possible implementation, as shown in FIG. 17, which is still another structural schematic diagram of a display panel according to an embodiment of the present disclosure, the non-display region NA includes a third non-display region NA3 and a fourth non-display region NA4 at opposite sides of the display region AA in a second direction y. The shielding trace 5 is connected to a first lead 16 in the third non-display region NA3, and the first lead 16 is further connected to a pin 17. That is, it means that the third non-display region NA3 is the lower bezel, and the fourth non-display region NA4 is the upper bezel.

The first shielding line 6 has a first break 18 in the fourth non-display region NA4.

In this case, the first shielding line 6 has a non-closed structure. The first shielding line 6 is disconnected in the upper bezel, and the disconnected position can refer to a main transmission point position of a whole machine’s antenna, thereby preventing the formation of a closed-loop from interfering with the whole machine’s radio frequency.

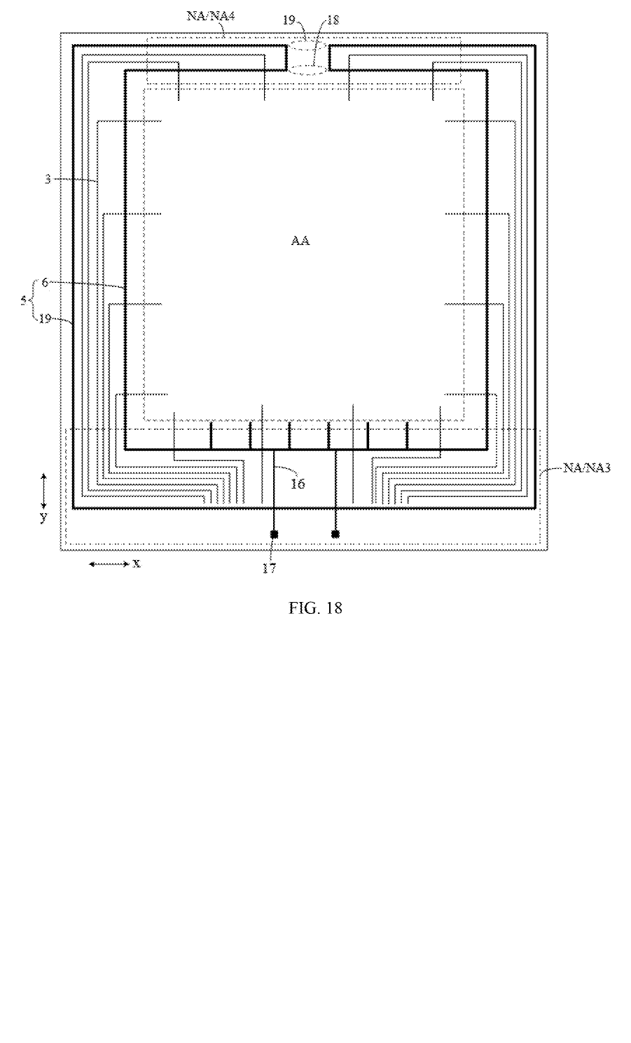

In a feasible implementation, as shown in FIG. 18, which is still another structural schematic diagram of a display panel according to an embodiment of the present disclosure, the shielding trace 5 further includes a second shielding line 19. The second shielding line 19 is located in the non-display region NA and at least partially surrounds the display region AA. The second shielding line 19 is electrically connected to the first shielding line 6.

The shielding trace 5 in this structure includes at least two shielding traces, namely, the first shielding line 6 and the second shielding line 19. In this way, an overall impedance of the shielding trace 5 can be reduced, thereby optimizing the transmission of the shielding signal.

In a feasible implementation, referring to FIG. 18, the non-display region NA further includes a third non-display region NA3 and a fourth non-display region NA4 at opposite sides of the display region AA in the second direction y. The shielding trace 5 is connected to a first lead 16 in the third non-display region NA3, and the first lead 16 is further connected to a pin 17. That is, it means that the third non-display region NA3 is the lower bezel, and the fourth non-display region NA4 is the upper bezel.

The second shielding line 19 is connected to the first shielding line 6 at least in the fourth non-display region NA4.

Compared with the lower bezel, the upper bezel has fewer wirings. The second shielding line 19 is selected to be connected to the first shielding line 6 at least in the upper bezel, which can facilitate the connection wiring between the two.

Further, the second shielding line 19 may also be provided with a second break 20 in the fourth non-display region NA4, and two ends of the second shielding line 19 at the second break 20 are respectively connected to two ends of the first shielding line 6 at the first break 18.

In a feasible implementation, referring to FIG. 18 again, the first shielding line 6 is located at a side of the touch line 3 close to the display region AA, and the second shielding line 19 is located at a side of the touch line 3 away from the display region AA. For example, a ground line for electrostatic protection is usually provided at an edge of the display panel, and the second shielding line 19 may be located between the touch line 3 and the ground line.

The light-emitting device layer includes a cathode. When arranging the touch line 3 in the display panel, it is desirable that the touch line 3 can be located above the cathode as much as possible to take advantage of the shielding effect provided by the cathode. This makes it unsuitable for the wiring position of the touch line 3 to be too far away from the display region AA. Therefore, when the first shielding line 6 is located between the touch line 3 and the display region AA, a certain restriction may be imposed on a line width of the first shielding line 6.

To this end, in the embodiment of the present disclosure, the second shielding line 19 is disposed at the periphery of the touch line 3, so that the line width of the second shielding line 19 is not restricted by the wiring position of the touch line 3, and the second shielding line 19 can have a larger line width to reduce the overall load of the shielding trace 5. In the embodiment of the present disclosure, a line width of at least some segments of the second shielding line 19 is greater than the line width of the first shielding line 6.

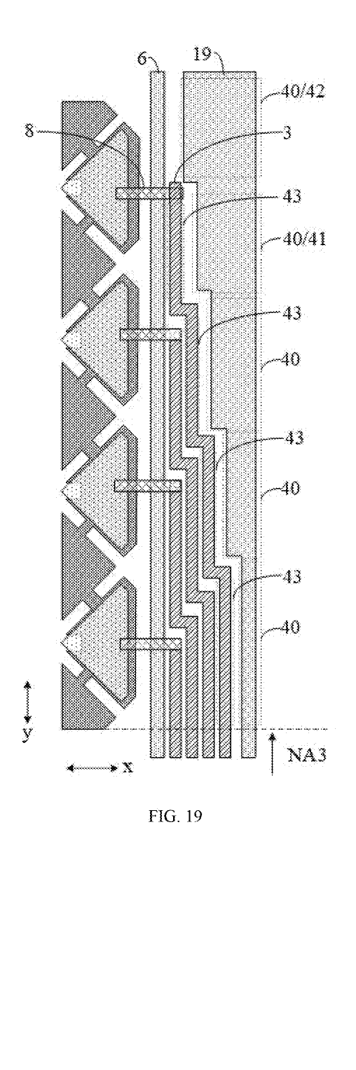

Further, in conjunction with FIGS. 18 and 19, where FIG. 19 is still another partial structural schematic diagram of a display panel according to an embodiment of the present disclosure, the second shielding line 19 includes a plurality of shielding segments 40 connected sequentially.

The shielding segments 40 include a first shielding segment 41 and a second shielding segment 42. The second shielding segment 42 is located at a side of the first shielding segment 41 away from the third non-display region NA3. A width of the second shielding segment 42 in a first direction x is greater than a width of the first shielding segment 41 in the first direction x.

In the left bezel and the right bezel, the farther away from the lower bezel, the fewer the number of the touch lines 3 arranged in the first direction x, and accordingly, the space available for arranging the second shielding line 19 becomes larger at positions farther away from the lower bezel. To this end, the line widths of the second shielding line 19 at different positions can be designed differently, making the second shielding segments 42 that are farther from the lower bezel wider, thereby using the wider second shielding segments 42 to weaken the overall load of the shielding trace 5.

Further, referring to FIG. 19, at least a part of the touch lines 3 each include a plurality of touch segments 43, and distances between the touch segments 43 and the touch electrode 2 gradually decrease in a direction away from the third non-display region NA3.

In the direction away from the third non-display region NA3, widths of the plurality shielding segments 40 in the second direction y gradually increase.

As described above, in the left bezel and the right bezel, the farther away from the lower bezel, the fewer the number of the touch lines 3. In the above-mentioned structure, the touch lines 3 in the left bezel and the right bezel adopt a polygonal line design. In a single touch line 3, in the direction from the lower bezel to the upper bezel, the distance between the touch line 3 and the display region AA gradually decreases, thereby releasing a complete space outside the touch line 3 that can be used for arranging the second shielding line 19. In turn, in this space, the widths of the shielding segments 40 in the second shielding line 19 tend to gradually increase, thereby optimizing the load design of the second shielding line 19.

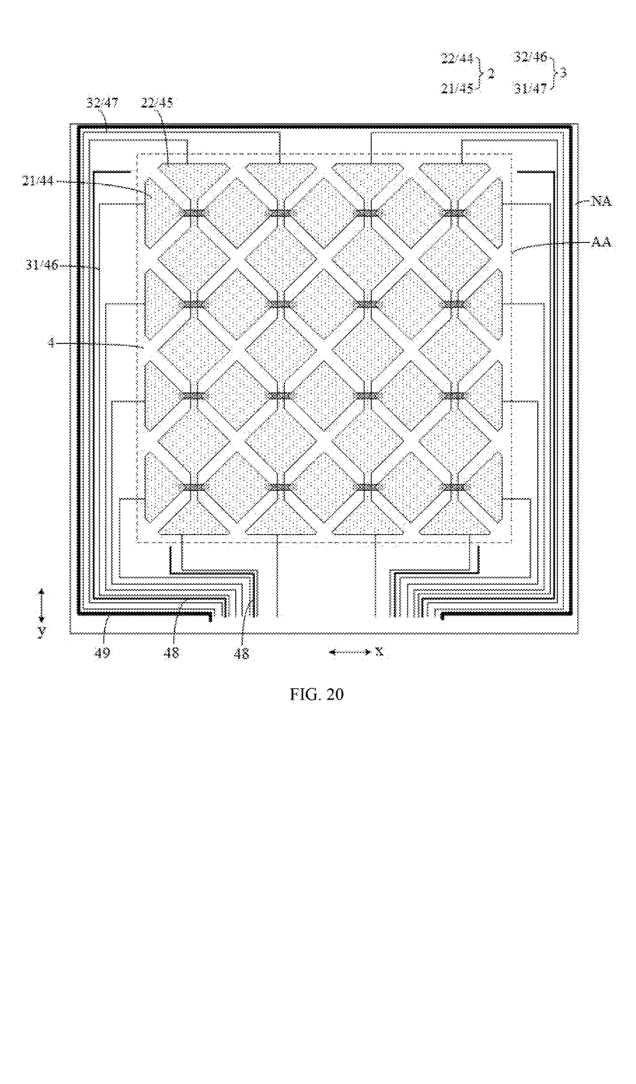

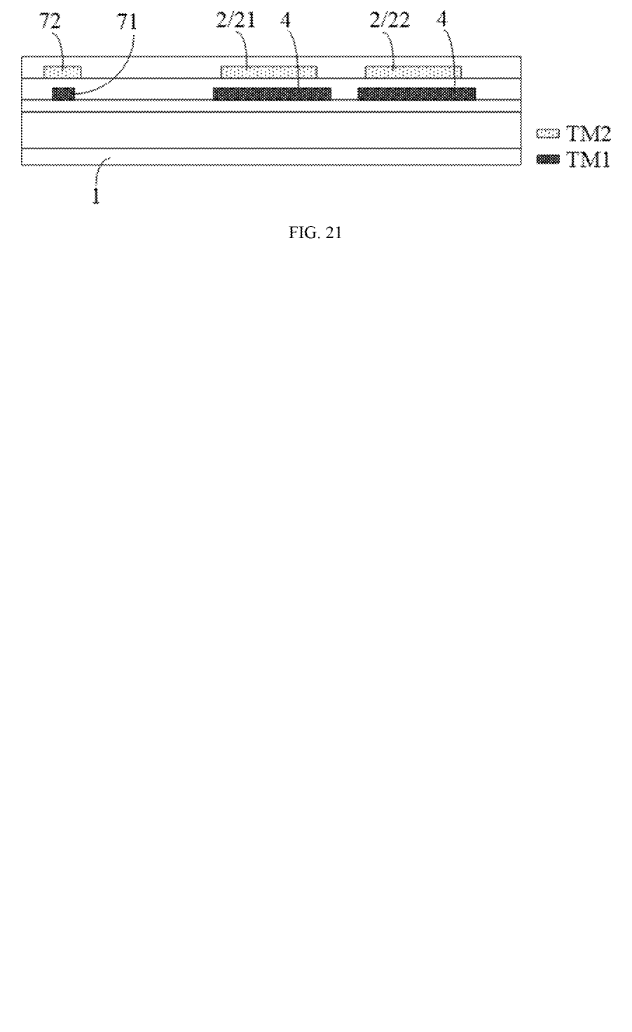

In a possible implementation, as shown in FIG. 20, which is still another structural schematic diagram of a display panel according to an embodiment of the present disclosure, the touch electrode 2 includes a driving electrode 44 and a sensing electrode 45. Accordingly, the touch line 3 includes a driving line 46 electrically connected to the driving electrode 44 and a sensing line 47 electrically connected to the sensing electrode 45.

In an embodiment of the present disclosure, one of the first touch electrode 21 and the second touch electrode 22 is the driving electrode 44, and the other is the sensing electrode 45. For example, in FIG. 20, the first touch electrode 21 is the driving electrode 44, and the second touch electrode 22 is the sensing electrode 45. Accordingly, the first touch line 31 is the driving line 46, and the second touch line 32 is the sensing line 47.

The non-display region NA further includes first protection lines 48. At least one of the first protection lines 48 is adjacent to the sensing line 47.

During touch detection, the driving line 46 provides a driving touch signal to the driving electrode 44, forming an electric field around it. Due to the presence of capacitance, this electric field can generate induced charges on the sensing electrode 45 opposite thereto. When a finger or a touch tool approaches a screen, the distribution of the electric field at a touch position is changed, causing a change in the amount of induced charge on the sensing electrode 45 at that position, and in turn a sensing touch signal is transmitted to a driving chip through the sensing line 47, enabling the driver chip to determine the touch position.

By providing the first protection lines 48 at positions adjacent to at least a part of the sensing lines 47, the first protection lines 48 can serve as shielding lines to reduce electromagnetic interference, lower signal crosstalk, and so on, thereby ensuring that signals transmitted on the sensing lines 47 are accurately and stably transmitted to the driving chip, and thus avoiding problems such as misjudgment.

Further, referring to FIG. 20 again, at least one of the first protection lines 48 is located between the sensing line 47 and the driving line 46. In addition to reducing signal crosstalk between the sensing line 47 and the driving line 46, the first protection line 48 can also absorb some high-frequency noise signals to prevent such signals from interfering with the signals on the sensing line 47 and the driving line 46, thereby improving signal quality. Moreover, the first protection line 48 can also balance electromagnetic field distribution around the sensing line 47 and the driving line 46 to a certain extent, thereby reducing distortion and reflection during signal transmission, ensuring signal integrity, and thus enhancing the noise resistance capability of the touch lines 3.

In a feasible implementation, referring to FIG. 20 again, the non-display region NA further includes a second protection line 49 located at a side of the touch line 3 away from the display region AA. The second protection line 49 can play a role of electrostatic protection to prevent electrostatic accumulation from affecting the touch line 3.

The first protection line 48 and the second protection line 49 each can receive a ground signal.

In a feasible implementation, in conjunction with FIG. 1, the touch electrode 2 includes a first touch electrode 21 and a second touch electrode 22; among a plurality of first touch electrodes 21 arranged in a first direction x, adjacent first touch electrodes 21 are electrically connected by a first connection portion 71; and among a plurality of second touch electrodes 22 arranged in a second direction y, adjacent second touch electrodes 22 are electrically connected through a second connection portion 72, where the second connection portion 72 and the first connection portion 71 are arranged in a crossed and insulated manner.

One of the first connection portion 71 and the second connection portion 72 is located in a same layer as the touch electrode 2, and the other one is located in a same layer as the shielding structure 4.

In the above structure, the shielding structure 4 is wired using the touch bridge layer TM1. Since the touch bridge layer TM1 is generally only used for arranging a bridge and the space occupied by the bridge is smaller, arranging the shielding structure 4 in the touch bridge layer TM1 can realize the rational utilization of the space of the touch bridge layer TM1. Moreover, the shielding structure 4 is located in the touch bridge layer TM1 and thus is closer to the touch electrode 2, resulting in a better shielding effect.

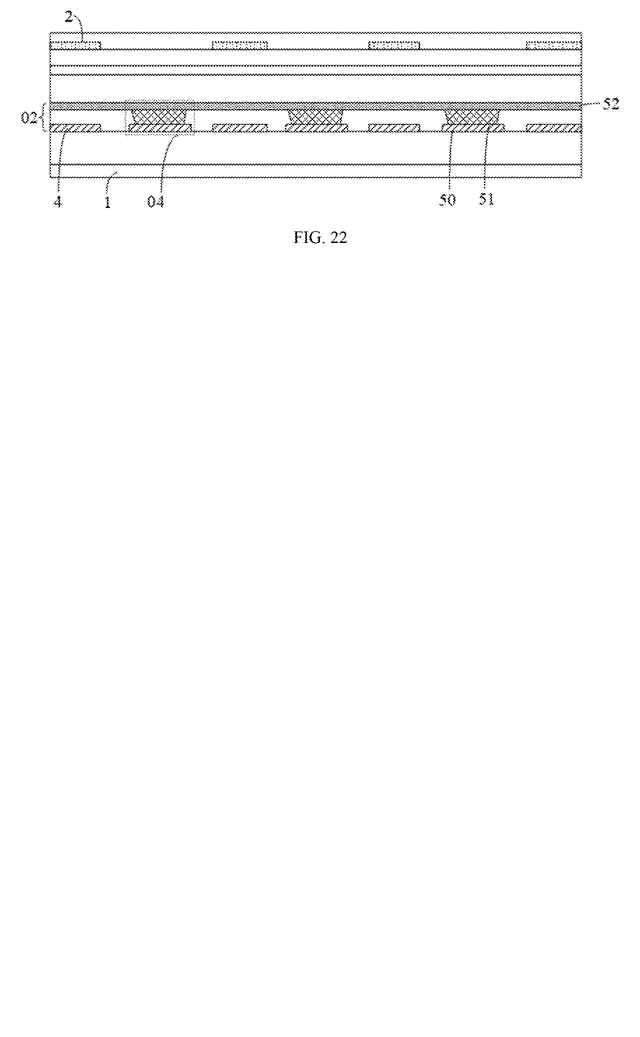

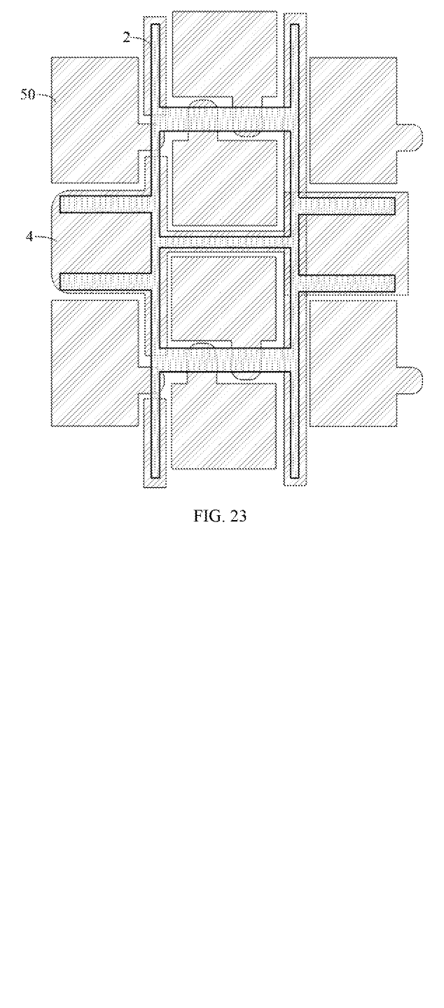

Or, in another feasible implementation, as shown in FIGS. 22 and 23, where FIG. 22 is a schematic diagram of yet another film layer structure of a display panel according to an embodiment of the present disclosure, and FIG. 23 is a structural schematic diagram of a shielding structure, an anode and a touch electrode according to an embodiment of the present disclosure, the display panel further includes a light-emitting device layer 02 located between the substrate 1 and the touch electrode 2. The light-emitting device layer 02 includes an anode 50, a light-emitting layer 51 and a cathode layer 52.

The shielding structure 4 can also be located in a same layer as the anode 50. Further, referring to FIG. 23, the shielding structure 4 may adopt rounded chamfer treatment in corner regions, with arcuate edges, so as to avoid electrostatic damage to the anode 50.

The position of the anode corresponds to the position of the light-emitting element 04. The shielding structure 4 is located in the same layer as the anode 50, and the shielding structure 4 avoids the anode 50, i.e., it means that the shielding structure 4 can present a grid structure exposing the light-emitting element. Moreover, when the shielding structure 4 is located in the same layer as the anode 50, the shielding structure 4 is closer to the touch electrode 2, resulting in a better shielding effect.

In addition, in an embodiment of the present disclosure, the cathode layer 52 can also be designed in a patterned manner. The cathode layer 52 includes two parts spaced apart from one another: one part acts as a cathode to provide a cathode voltage required by the light-emitting element, and the other part acts as a shielding metal, whose position may correspond to the position of the shielding structure.

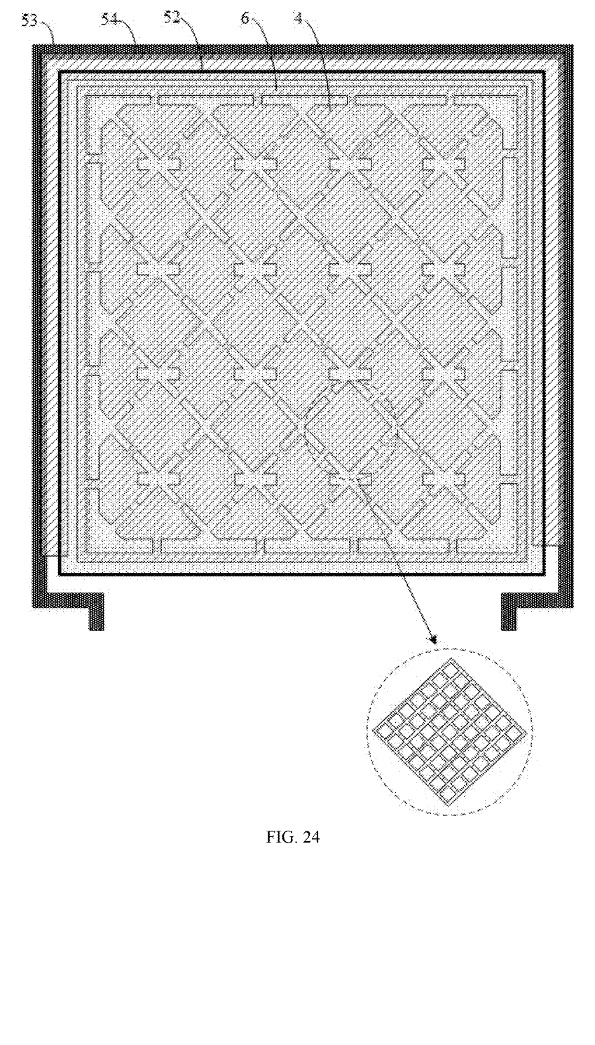

In a feasible implementation, as shown in FIG. 24, which is still another structural schematic diagram of a display panel according to an embodiment of the present disclosure, the non-display region NA further includes a cathode bus 53, and the cathode layer 52 is connected to the cathode bus 53 through a lap metal 54.

The first shielding line 6 is located in a same layer as the lap metal 54 and the anode 50, and the first shielding line 6 is located at a side of the lap metal 54 close to the display region AA.

When the first shielding line 6 is located in the same layer as the lap metal 54, the first shielding line 6 is located inside the lap metal 54 to facilitate connection with the shielding structure 4. For example, the first shielding line 6 and the shielding structure 4 can be directly connected via the first connection line 7 in the same layer, and the first connection line 7 will not conflict with the lap metal in position.

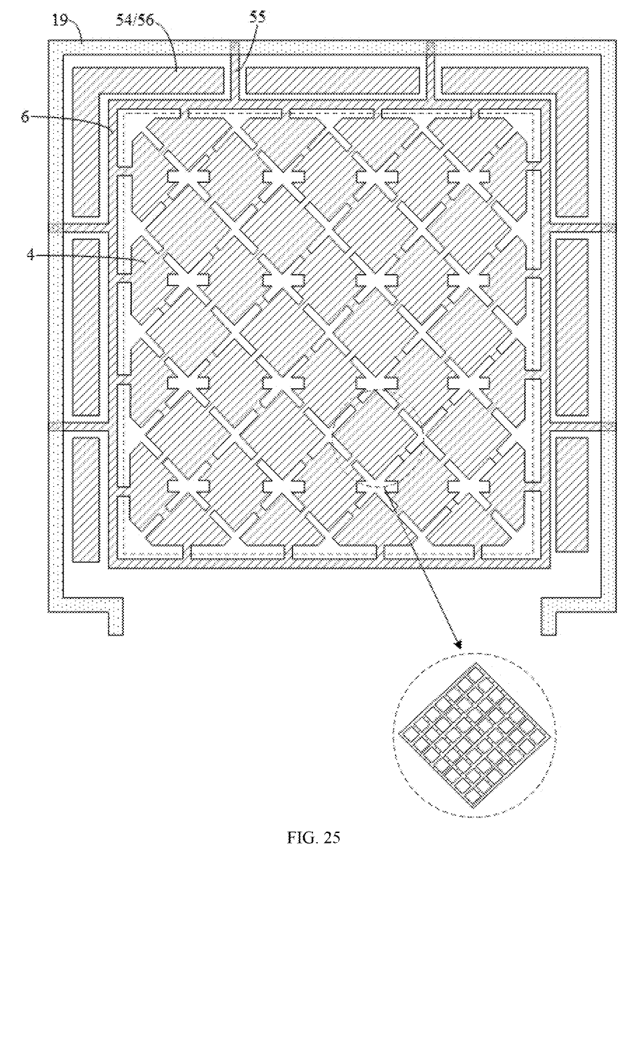

Further, as shown in FIG. 25, which is still another structural schematic diagram of a display panel according to an embodiment of the present disclosure, the shielding trace 5 further includes a second shielding line 19 located at a side of the lap metal 54 away from the display region AA. The second shielding line 19 is electrically connected to the first shielding line 6 through a third connection line 55.

The third connection line 55 is located in a same layer as the anode 50. The lap metal 54 includes a plurality of lap sub-metals 56 spaced apart from one another. The third connection line 55 is located between adjacent lap sub-metals 56.

The third connection line 55 is located in the same layer as the anode 50, so that the number of film layers can be saved. Further, the lap metal 54 is divided into the plurality of lap sub-metals 56 spaced apart from one another, and the third connection line 55 is allowed to extend within an interval between adjacent lap sub-metals 56, which can enable the lap metal 54 and the third connection line 55 to avoid each other, thereby achieving reasonable wiring between the lap metal 54 and the third connection line 55.

Further, when the second shielding line 19 is located at the side of the lap metal 54 away from the display region AA, the second shielding line 19 can be disposed in a same layer as the touch electrode 2, that is, located in the touch metal layer TM2.

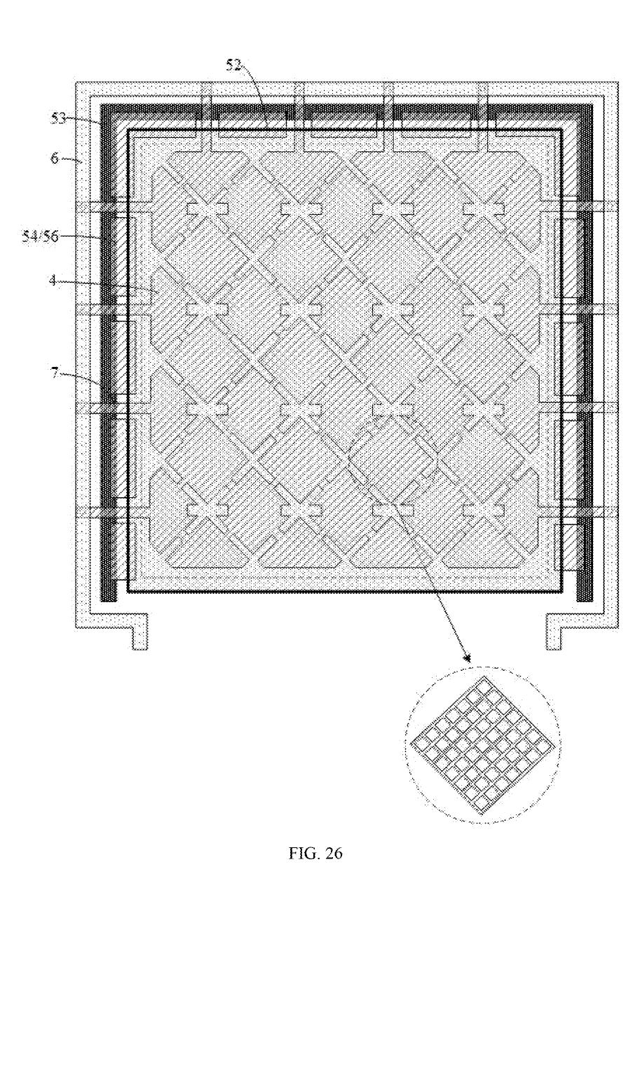

In a feasible implementation, as shown in FIG. 26, which is still another structural schematic diagram of a display panel according to an embodiment of the present disclosure, the non-display region NA further includes a cathode bus 53, and the cathode layer 52 is connected to the cathode bus 53 through a lap metal 54.

The first shielding line 6 is located at a side of the lap metal 54 away from the display region AA. The first shielding line 6 is connected to the shielding structure 4 through a plurality of first connection lines 7. The plurality of first connection lines 7 are located in a same layer as the lap metal 54 and the anode 50. The lap metal 54 includes a plurality of lap sub-metals 56 spaced apart from one another. One first connection line 7 of the plurality of first connection lines 7 is disposed between adjacent lap sub-metals 56.

The first connection lines 7 are located in the same layer as the anode 50, so that the number of film layers can be saved. Further, the lap metal 54 is divided into a plurality of lap sub-metals 56 spaced apart from one another, and the first connection line 7 is allowed to extend within an interval between adjacent lap sub-metals 56, which can enable the lap metal 54 and the first connection line 7 to avoid each other, thereby achieving reasonable wiring between the lap metal 54 and the first connection line 7.

Further, when the first shielding line 6 is located at the side of the lap metal 54 away from the display region AA, the first shielding line 6 can be disposed in a same layer as the touch electrode 2, that is, located in the touch metal layer TM2.

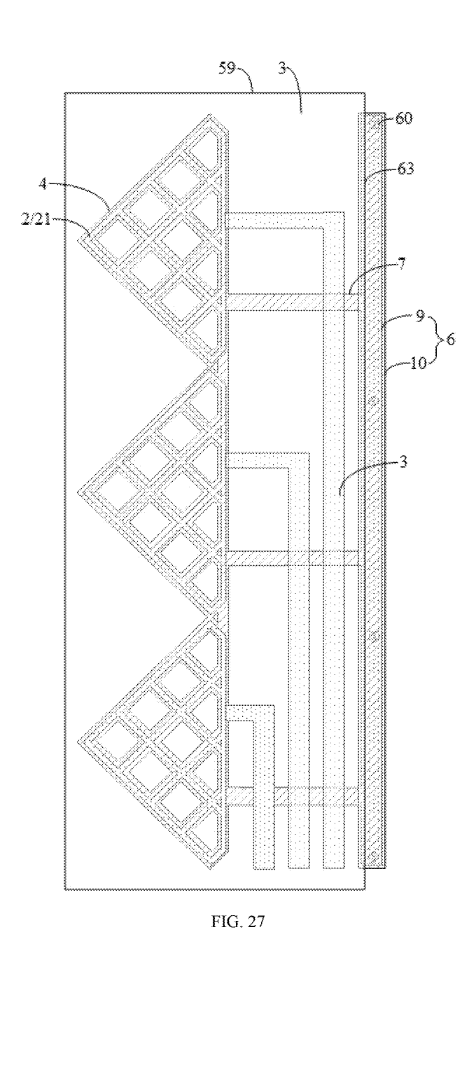

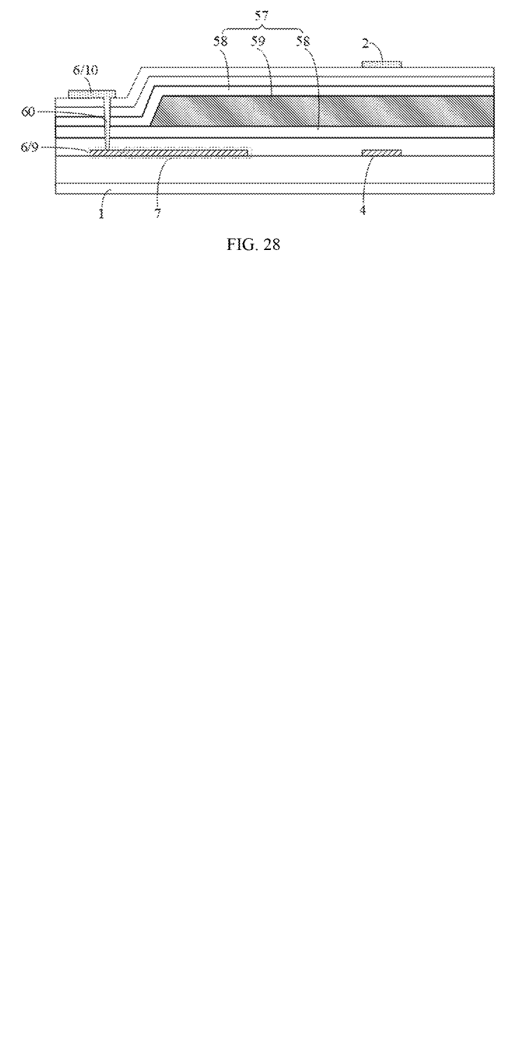

In a feasible implementation, as shown in FIGS. 27 and 28, where FIG. 27 is still another partial structural schematic diagram of a display panel according to an embodiment of the present disclosure, and FIG. 28 is a schematic diagram of still another film layer structure of a display panel according to an embodiment of the present disclosure, the display panel further includes an encapsulation film layer 57 including an inorganic encapsulation layer 58 and an organic encapsulation layer 59. The organic encapsulation layer 59 includes a first edge 63.

At least a part of the first shielding line 6 is located at a side of the first edge 63 away from the display region AA.

The first shielding line 6 includes a first shielding sub-line 9 and a second shielding sub-line 10 that are located in different layers and electrically connected to each other, connection via-holes 60 are provided between the first shielding sub-line 9 and the second shielding sub-line 10, and the connection via-holes 60 are also located at the side of the first edge 63 away from the display region AA. Further, the first shielding sub-line 9 can be located in a same layer as the anode 50 and in turn directly communicate with the shielding structure 4 and the first connection line 7, and the second shielding sub-line 10 can be located in a same layer as the touch electrode 2.

When at least a part of the first shielding line 6 and the connection via-holes 60 in the two wiring layers thereof are both located outside the first edge 63 of the organic encapsulation layer 59, it means that the first shielding line 6 and the connection via-holes 60 can be positioned more outward, which in turn can prevent them from affecting the wiring of other existing traces in the non-display region NA.

Compared with the organic encapsulation layer 59, an edge of the inorganic encapsulation layer 58 is positioned more outward, that is, closer to the edge of the display panel. Further, in an embodiment of the present disclosure, at least a part of the first shielding line 6 and the connection via-holes 60 in the two wiring layers thereof may be located at a side of the edge of the inorganic encapsulation layer 58 away from the display region AA.

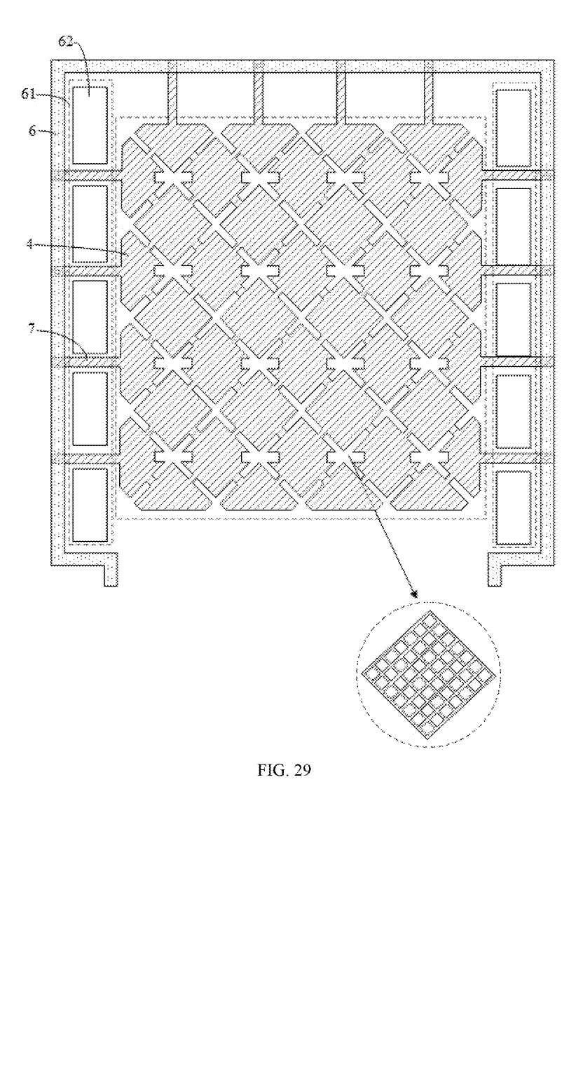

In order to provide a driving signal to the pixel circuit in the display region AA, a shift register is generally provided in the non-display region NA. In a feasible implementation, as shown in FIG. 29, which is still another structural schematic diagram of a display panel according to an embodiment of the present disclosure, the non-display region NA further includes a first shift register 61. The first shift register 61 includes a plurality of cascaded first shift units 62. When the shielding structure 4 is connected to the first shielding line 6 through the first connection line 7 and the first connection line 7 is located in the same layer as the anode, the first connection line 7 is closer to the array layer. To reduce coupling between the first connection line 7 and a metal trace in the first shift unit 62, the first connection line 7 can be located between adjacent first shift units 62. That is to say, after leading out the first connection line 7 from the shielding structure 4, the first connection line 7 extends from an interval between adjacent first shift units 62 to be connected to the first shielding line 6.

In a feasible implementation, the shielding trace 5 can receive a fixed voltage, such as the ground signal, thereby enabling the shielding structure 4 to achieve the shielding function.

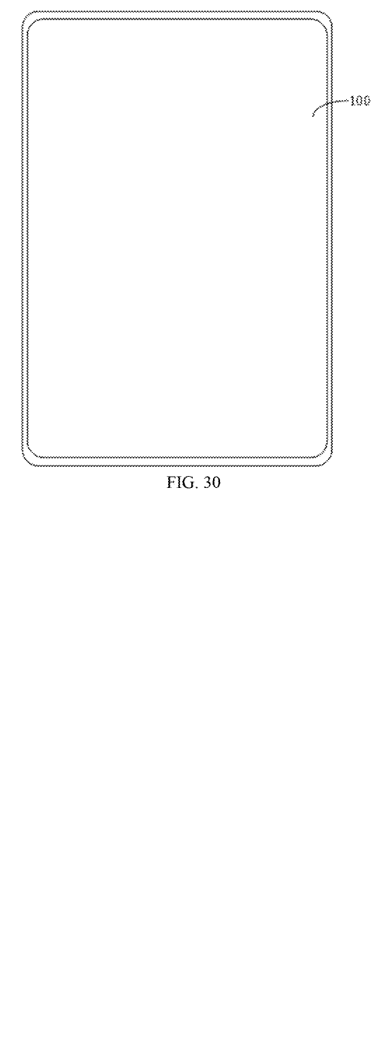

Based on the same inventive concept, an embodiment of the present disclosure further provides a display apparatus. As shown in FIG. 30, which is a structural schematic diagram of a display apparatus according to an embodiment of the present disclosure, the display apparatus includes the above-mentioned display panel 100. Of course, the display apparatus shown in FIG. 30 is merely for the purpose of illustration, and the display apparatus may be any electronic device having a display function such as a mobile phone, a tablet computer, a notebook computer, an e-book, and a television.

The above-described are only preferred embodiments of the present disclosure and are not intended to limit the present disclosure. All modifications, equivalent replacements, improvements, etc., made within the spirit and principle of the present disclosure shall be included within the scope of protection of the present disclosure.

Finally, it should be noted that, the above embodiments are merely used to illustrate the technical solutions of the present disclosure, but not to limit the same. Although the present disclosure has been described in detail with reference to the above embodiments, those of skill in the art should understand that the technical solutions recited in the above embodiments of the present disclosure may still be modified, or some or all of the technical features in them may be equivalently replaced. These modifications or substitutions do not make the essence of the corresponding technical solutions depart from the scope of the technical solutions in the embodiments of the present disclosure.

What is claimed is:

1. A display panel, comprising:
a display region and a non-display region;
a substrate;
a touch electrode and a touch line, wherein the touch electrode is at least located in the display region, and the touch line is electrically connected to the touch electrode and located in the non-display region;
a shielding structure located between the substrate and the touch electrode, wherein the shielding structure overlaps with the touch electrode in a direction perpendicular to a plane of the substrate; and
a shielding trace comprising a first shielding line, wherein the first shielding line is located in the non-display region and at least partially surrounds the display region, and the first shielding line is electrically connected to the shielding structure; and the shielding trace receives a fixed voltage.

2. The display panel according to claim 1, wherein
the first shielding line is located at a side of the touch line close to the display region.

3. The display panel according to claim 1, wherein
the shielding structure is connected to the first shielding line through a first connection line.

4. The display panel according to claim 3, wherein
the shielding structure is electrically connected to the first shielding line through a plurality of first connection lines, and among multiple first connection lines arranged in a same direction, distances between adjacent first connection lines are equal.

5. The display panel according to claim 3, wherein
the touch electrode is connected to the touch line through a second connection line, and the second connection line and the first connection line are arranged in a same layer or in different layers.

6. The display panel according to claim 5, wherein
m first connection lines are disposed between adjacent second connection lines, wherein m is an integer greater than or equal to 1.

7. The display panel according to claim 6, wherein
a distance between the second connection line and the first connection line adjacent thereto is a first distance;
among the m first connection lines between the adjacent second connection lines, a distance between adjacent first connection lines is a second distance, and the first distance is greater than the second distance; and
m≥2.

8. The display panel according to claim 5, wherein
the first shielding line is located at a side of the touch line close to the display region, the first shielding line comprises a first shielding sub-line and a second shielding sub-line located in different layers and electrically connected to each other, and the first shielding sub-line overlaps with the second shielding sub-line in the direction perpendicular to the plane of the substrate; and
the second connection line and the first shielding sub-line are located in a first metal layer, and the second shielding sub-line is located in a second metal layer; and the first shielding sub-line comprises a plurality of first segments spaced apart from one another, and the second connection line is disposed between adjacent first segments.

9. The display panel according to claim 8, wherein
the first connection line is located in a same layer as the first segments, and the first connection line electrically connected to one first segment of the first segments and the shielding structure; and
in an arrangement direction of the plurality of first segments, a length of the first connection line is equal to a length of the first segment connected thereto, and at least a part of the first connection line does not overlap with the touch electrode and the second shielding sub-line in the direction perpendicular to the plane of the display panel.

10. The display panel according to claim 5, wherein
the first connection line and the second connection line are located in different layers; and
the first connection line and the first shielding line are at least partially located in a same layer, and the second connection line and the touch line are at least partially located in a same layer.

11. The display panel according to claim 10, wherein
at least a part of the touch line is located at a side of the first connection line away from the substrate, and the first connection line overlaps with the touch line in the direction perpendicular to the plane of the substrate.

12. The display panel according to claim 10, wherein
the first connection line comprises a hollow not overlapping with the touch line in the direction perpendicular to the plane of the substrate.

13. The display panel according to claim 1, wherein
the non-display region comprises a third non-display region and a fourth non-display region located at two opposite sides of the display region in a second direction, wherein the shielding trace is connected to a first lead in the third non-display region, and the first lead is further connected to a pin; and
the first shielding line has a first break in the fourth non-display region.

14. The display panel according to claim 1, wherein
the shielding trace further comprises a second shielding line, the second shielding line is located in the non-display region and at least partially surrounds the display region, and the second shielding line is electrically connected to the first shielding line.

15. The display panel according to claim 14, wherein
the non-display region comprises a third non-display region and a fourth non-display region located at two opposite sides of the display region in the second direction, wherein the shielding trace is electrically connected to a first lead in the third non-display region, and the first lead is further connected to a pin; and
the second shielding line is connected to the first shielding line at least in the fourth non-display region.

16. The display panel according to claim 14, wherein
the first shielding line is located at a side of the touch line close to the display region, and the second shielding line is located at a side of the touch line away from the display region.

17. The display panel according to claim 16, wherein
the non-display region comprises a third non-display region located at a side of the display region in a second direction, the shielding trace is connected to a first lead in the third non-display region, and the first lead is further connected to a pin; and
the second shielding line comprises a plurality of shielding segments connected sequentially, the plurality of shielding segments comprise a first shielding segment and a second shielding segment, the second shielding segment is located at a side of the first shielding segment away from the third non-display region, a width of the second shielding segment in a first direction is greater than a width of the first shielding segment in the first direction, and the first direction intersects with the second direction.

18. The display panel according to claim 1, wherein
the touch electrode comprises a driving electrode and a sensing electrode;
the touch line comprises a driving line electrically connected to the driving electrode and a sensing line electrically connected to the sensing electrode; and
the non-display region further comprises first protection lines, and at least one of the first protection lines is adjacent to the sensing line.

19. The display panel according to claim 18, wherein
at least one of the first protection lines is located between the sensing line and the driving line.

20. A display apparatus, comprising a display panel, wherein the display panel comprises:
a display region and a non-display region;
a substrate;
a touch electrode and a touch line, wherein the touch electrode is at least located in the display region, and the touch line is electrically connected to the touch electrode and located in the non-display region;
a shielding structure located between the substrate and the touch electrode, wherein the shielding structure overlaps with the touch electrode in a direction perpendicular to a plane of the substrate; and
a shielding trace comprising a first shielding line, wherein the first shielding line is located in the non-display region and at least partially surrounds the display region, and the first shielding line is electrically connected to the shielding structure; and the shielding trace receives a fixed voltage.
